(19) United States
(12) Patent Application Publication
(10) Pub. No.: US 2026/0227180 A1
(43) Pub. Date: Aug. 6, 2026

(54) METHOD FOR CALIBRATING AT LEAST ONE PROJECTOR OF A 3D SCANNER AND 3D SCANNING SYSTEM IMPLEMENTING SAID METHOD

(71) Applicant: CREAFORM INC., Lévis (CA)

(72) Inventors: Alexandre Carette, Quebec (CA); Jean-Nicolas Ouellet, Saint-Augustin de Desmaures (CA); Eric St-Pierre, Lévis (CA)

(21) Appl. No.: 19/152,038

(22) PCT Filed: Dec. 19, 2023
(86) PCT No.: PCT/CA2023/051702

§ 371 Date: Jul. 30, 2025

Related U.S. Application Data
(60) Provisional application No. 63/509,407, filed on Jun. 21, 2023.
(60) Provisional application No. 63/589,178, filed on Oct. 10, 2023.

(51) Int. Cl. G01B 11/25

(52) U.S. Cl. CPC G01B 11/2504; G01B 11/2545

(57) ABSTRACT

A method and system are provided for calibrating a three-dimensional (3D) scanner having a projector, a set of cameras and a processor. The projector projects a plurality of light elements which resolve as a light pattern on a surface of an object. A plurality of frames of the surface is captured with the set of cameras. The processor processes the set of images to generate 3D measurements of a light element of the plurality of light elements and derive at least one projector parameter based on the 3D measurements of the light element by grouping the 3D measurements into a plurality of centroids or by integrating the 3D measurements into a linearized point matching system. The processor then calibrates a reference light element equation representing the at least one light element with the at least one projector parameter to generate a calibrated reference light element equation.

### TECHNICAL FIELD

The present disclosure generally relates to the field of measuring devices and methods, and, more particularly, to systems and methods for calibrating handheld three-dimensional (3D) scanners.

### BACKGROUND

Transportable measuring systems such as handheld three-dimensional (3D) scanners are used for generating 3D measurements of a surface of a target object and generating 3D representations (such as 3D point clouds and/or 3D meshes) of such surfaces. For example, conventional handheld scanners comprise imaging modules such as at least two cameras rigidly fixed with respect to each other (e.g., a “stereo camera” configuration) which may be used to capture images of surfaces. Scanning of the surfaces can be achieved by moving the handheld 3D scanner to several different poses having corresponding different viewpoints of the target object and capturing a portion of the surface of the target object at each viewpoint with the imaging modules. Images of the surface of the target object from different viewpoints may then be analyzed to extract 3D measurements therefrom and may then be combined using various techniques (including triangulation, bundle adjustment and other pose graph optimization techniques) in order to create a 3D representation of the object.

A challenge in a stereo camera 3D measurement is how to accurately match features of images obtained from the two different viewpoints (e.g., by the two different cameras). An approach for simplifying feature matching between images includes the use of a light projector that projects a plurality of light planes (or any other type of light elements) oriented in a known configuration towards the target object being scanned. The projected light planes resolve as a corresponding two-dimensional (2D) plurality of light lines (or any other type of corresponding 2D light element) on the surface of the target object. The images captured by the at least two cameras include representations of the light lines as distorted by the surface of the target object. By leveraging a known baseline orientation of the projected light planes, in combination with known baseline separation distances between the different cameras and between each camera and an origin of the projector and known baseline orientations of the two different cameras, features belonging to a same light line can be more accurately and efficiently matched between different images and the corresponding 3D measurement of a feature on the surface of the target object can be more accurately derived.

The baseline orientation and the baseline separation distances may initially be factory calibrated when a particular 3D scanner is manufactured by a manufacturer and potentially also when the 3D scanner is sent back to the manufacturer for service. However, during the lifetime of the 3D scanner and while the 3D scanner is in the possession of an operator, the cameras and projector may move or shift relative to each other, such as due to impact forces or mechanical stress on the 3D scanner, due to changes in temperature, due to changes in altitude, or due to other environmental factors such as humidity, dust or debris. Such shifts or movements can cause corresponding changes to the baseline orientation of the light planes and cameras, as well as corresponding changes to the baseline separation distance of the projector and cameras, in a manner that can affect accuracy of the 3D scanner. It may be necessary to re-calibrate the orientation and separation distances while the 3D scanner is in the possession of an operator.

In some existing 3D scanning systems, this re-calibration of orientation of the light planes and cameras and separation distances between the projector and cameras may be a dedicated calibration procedure involving scanning, with the 3D scanner, a calibration object separate from the target object (such as a calibration plate) and/or a reference object associated with the target object. This dedicated calibration procedure is performed before the 3D scanner is used to scan the target object to obtain the 3D measurements of the surface of the target object. However, such dedicated calibration procedures may be inconvenient and onerous for an operator, and may be susceptible to operator error in situations where the operator does not scan the reference artifact or the calibration object completely or properly. Additionally, 3D scanners having a large field of view (FOV) or a deep depth of field (DOF) may require large calibration objects or large reference objects in order to calibrate the entire FOV or DOF of the 3D scanner. Such large calibration or reference objects may be inconvenient to store and transport with the corresponding 3D scanners.

Against the background described above, there remains a need in the industry to provide improved handheld 3D scanners that alleviate at least some of the deficiencies noted above.

### SUMMARY

The summaries below are provided to introduce a selection of concepts in a simplified form that are further described below in the Detailed Description. This Summary is not intended to identify all key aspects and/or essential aspects of the claimed subject matter.

In one embodiment, there is provided a method for calibrating a three-dimensional (3D) scanner having a projector, a set of cameras and at least one processor in communication with the projector and the set of cameras. The method comprises: a. projecting, with the projector, a plurality of light elements which resolve as a light pattern on a surface of an object; and b. capturing, with the set of cameras, a plurality of frames of the surface, wherein a set of images of the plurality of frames include data conveying a representation of at least a portion of the light pattern on the surface and at least a portion of the surface. The method further comprises: c. processing, with the at least one processor, the set of images to: i. generate 3D measurements of the surface by processing the representation of at least the portion of the surface in the set of images; and ii. generate 3D measurements of at least one light element of the plurality of light elements by processing the representation of at least the portion of the light pattern on the surface in the set of images. The method further comprises: d. grouping, with the at least one processor, the 3D measurements of the at least one light element into a plurality of centroids, each centroid of the plurality of centroids representing a collapsed version of a subset of the 3D measurements of the at least one light element; e. processing, with the at least one processor, the plurality of centroids to derive at least one projector parameter; and f. calibrating, with the at least one processor, a reference light element corresponding to the at least one light element and represented by a reference light element equation with the at least one projector parameter to generate a calibrated reference light element equation.

Grouping the 3D measurements of the at least one light element into the plurality of centroids may comprise: a. dividing, with the at least one processor, a scanner field-of-view (FOV) into a plurality of voxels, wherein a set of voxels of the plurality of voxels are associated with the at least one light element; and b. grouping, with the at least one processor, the 3D measurements of the at least one light element within each voxel of the set of voxels into a centroid, wherein centroids of each voxel of the set of voxels associated with the at least one light element comprise the plurality of centroids.

Deriving the at least one projector parameter based on the plurality of centroids may comprise at least one of: a. performing an iterative closest point operation between the plurality of centroids and points of the reference light element; or b. integrating the plurality of centroids into a linearized point matching system.

The at least one projector parameter may comprise at least one of: a. a rotation matrix of the 3D measurements of the at least one light element relative to the reference light element; or b. a translation vector of the 3D measurements of the at least one light element relative to the reference light element.

In another embodiment, there is provided a method for calibrating a three-dimensional (3D) scanner having a projector, a set of cameras and at least one processor in communication with the projector and the set of cameras. The method comprises: a. projecting, with the projector, a plurality of light elements which resolve as a light pattern on a surface of an object; and b. capturing, with the set of cameras, a plurality of frames of the surface, wherein a set of images of the plurality of frames include data conveying a representation of at least a portion of the light pattern on the surface and at least a portion of the surface. The method further comprises: c. processing, with the at least one processor, the set of images to: iii. generate 3D measurements of the surface by processing the representation of at least the portion of the surface in the set of images; and iv. generate 3D measurements of at least one light element of the plurality of light elements by processing the representation of at least the portion of the light pattern on the surface in the set of images. The method further comprises: d. integrating, with the at least one processor, the 3D measurements of the at least one light element into a linearized point matching system; e. processing, with the at least one processor, the linearized point matching system to derive at least one projector parameter; and f. calibrating, with the at least one processor, a reference light element corresponding to the at least one light element and represented by a reference light element equation with the at least one projector parameter to generate a calibrated reference light element equation.

The linearized point matching system may comprise a linearized iterative closest point operation between the 3D measurements of the at least one light element and points of the reference light element. Integrating the 3D measurements of the at least one light element into the linearized point matching system may comprise: a. generating at least one matrix based on the 3D measurements of the at least one light element and the points of the reference light element; and b. integrating the at least one matrix into the linearized iterative closest point operation to generate the at least one projector parameter.

The at least one matrix may comprise: a. a covariance matrix of normal vectors and torque vectors of the 3D measurements of the at least one light element relative to points of the reference light element; and b. a residual vector of the linearized iterative closest point operation.

Generating the at least one matrix based on the 3D measurements of the at least one light element may comprise generating a respective at least one matrix for each image of the set of images. Integrating the at least one matrix into the linearized iterative closest point operation may comprise integrating each respective at least one matrix generated based on each image of the set of images into the linearized iterative closest point operation.

The at least one projector parameter may comprise at least one of: a. a rotation vector of the 3D measurements of the at least one light element relative to the points of the reference light element; or b. a translation vector of the 3D measurements of the at least one light element relative to the points of the reference light element.

The rotation vector of the 3D measurements of the at least one light element relative to the points of the reference light element may comprise a linearized rotation matrix of the 3D measurements of the at least one light element relative to the points of the reference light element.

The reference light element equation may comprise an initial reference light element equation.

The method may further comprise storing at least one of the at least one projector parameter or the calibrated reference light element equation in storage memory.

The plurality of light elements may comprise a plurality of light planes and the reference light element comprises a plurality of reference light planes, wherein every light plane of the plurality of light planes may correspond to a respective reference light plane of the plurality of reference light planes.

The at least one projector parameter may be derived at least one of: a. at least in part while images of the set of images or the plurality of frames are being processed with the at least one processor to generate the 3D measurements of the surface; b. at least in part while capturing additional images of the plurality of frames or additional images of the set of images with the set of cameras; c. after processing images of the set of images or the plurality of frames with the at least one processor to generate the 3D measurements of the surface; or d. after capturing images of the set of images or images of the plurality of frames with the set of cameras.

The plurality of frames may comprise a plurality of subsets of frames and wherein the at least one projector parameter may be derived at intervals after capturing images of a subset of the plurality of subsets of frames with the set of cameras.

The method may further comprise causing the at least one processor to generate the 3D measurements of the surface based on least in part on the calibrated reference light element equation.

The plurality of frames may form a first set of frames. The method may further comprise: a. capturing, with the set of cameras, a second set of frames of the surface; and b. processing, with the at least one processor, the second set of frames to generate further 3D measurements of the surface based at least in part on the calibrated reference light element equation.

The object may have a scale artifact fixedly associated with the object and wherein the set of images may include data conveying a representation of at least a portion of the scale artifact. Processing the set of images may further comprise: a. processing, with the at least one processor, the set of images to derive at least one derivable camera parameter of the set of cameras by processing dimension information corresponding to the scale artifact and the representation of at least the portion of the scale artifact in the set of images.

The scale artifact may include a physical scale element and a nominal scale element, wherein the nominal scale element may provide the dimension information of the physical scale element.

The set of cameras may comprise a first camera and a second camera and the at least one derivable camera parameter may comprise a camera separation distance between the first camera and the second camera.

The at least one derivable camera parameter may comprise respective separation distances between respective cameras of the set of cameras and an origin point of the scanner.

The method may further comprise calibrating, with the at least one processor, one or more calibratable camera parameters of the set of cameras at least in part using the at least one derivable camera parameter.

The one or more calibratable camera parameters may comprise one or more extrinsic camera parameters.

The one or more calibratable camera parameters may comprise one or more intrinsic camera parameters.

The at least one derivable camera parameter may be derived at least one of: a. at least in part while images of the plurality of frames or the set of images are being processed with the at least one processor to generate the 3D measurements of the surface; b. at least in part while capturing additional images of the plurality of frames or additional images of the set of images with the set of cameras; or c. after processing the plurality of frames or the set of images with the at least one processor to generate the 3D measurements of the surface or after capturing images of the plurality of frames or the set of images with the set of cameras.

In another embodiment, there is provided a scanner comprising the set of cameras, the projector and the at least one processor. The set of cameras, the projector and the at least one processor is configured to perform the method described above or any variants thereof.

In another embodiment, there is provided a method for calibrating a three-dimensional (3D) scanner having a projector, a set of cameras and at least one processor in communication with the projector and the set of cameras. The method comprises: a. projecting, with the projector, a plurality of light elements which resolve as a light pattern on a surface of an object; b. capturing, with the set of cameras, a plurality of frames of the surface, wherein a set of images of a frame of the plurality of frames include data conveying a representation of at least a portion of the light pattern on the surface and at least a portion of the surface; and c. processing, with the at least one processor, the set of images to generate 3D measurements of at least one light element of the plurality of light elements by processing the representation of at least the portion of the light pattern on the surface in the set of images. The method further comprises: d. deriving, with the at least one processor, at least one projector parameter based on the 3D measurements of the at least one light element by at least one of: i. grouping, with the at least one processor, the 3D measurements of the at least one light element into a plurality of centroids; or ii. integrating, with the at least one processor, the 3D measurements of the at least one light element into a linearized point matching system. The method further comprises: e. calibrating, with the at least one processor, a reference light element representing the at least one light element with the at least one projector parameter to generate a calibrated reference light element.

In another embodiment, there is provided a three-dimensional (3D) scanner comprising: a. a projector configured to project a plurality of light elements which resolve as a light pattern on a surface of an object; and b. a set of cameras configured to capture a plurality of frames of the surface, wherein a set of images of the plurality of frames includes data conveying a representation of at least a portion of the light pattern and at least a portion of the surface. The scanner further comprises: c. at least one processor in communication with the set of cameras, the at least one processor configured to: i. process the set of images to: A. generate 3D measurements of the surface by processing the representation of at least the portion of the surface in the set of images; and B. generate 3D measurements of at least one light element of the plurality of light elements by processing the representation of at least the portion of the light pattern in the set of images. The at least one processor is further configured to: ii. group the 3D measurements of the at least one light element into a plurality of centroids, each centroid of the plurality of centroids representing a collapsed version of a subset of the 3D measurements of the at least one light element; iii. derive at least one projector parameter based on the plurality of centroids; and iv. calibrate a reference light element corresponding to the at least one light element and represented by a reference light element equation with the at least one projector parameter to generate a calibrated reference light element equation.

The at least one processor may be configured to group the 3D measurements of the at least one light element into the plurality of centroids by being configured to: a. divide a scanner field-of-view (FOV) into a plurality of voxels, wherein a set of voxels of the plurality of voxels are associated with the at least one light element; and b. group the 3D measurements of the at least one light element within each voxel of the set of voxels into a centroid, wherein centroids of each voxel of the set of voxels associated with the at least one light element comprise the plurality of centroids.

The at least one projector parameter may comprise at least one of: a. a rotation matrix of the 3D measurements of the at least one light element relative to the reference light element; or b. a translation vector of the 3D measurements of the at least one light element relative to the reference light element.

The at least one processor may be configured to derive the at least one projector parameter based on the plurality of centroids by being configured to at least one of: a. perform an iterative closest point operation between the plurality of centroids and points of the reference light element; or b. integrate the plurality of centroids into a linearized point matching system.

In another embodiment, there is provided a three-dimensional (3D) scanner comprising: a. a projector configured to project a plurality of light elements which resolve as a light pattern on a surface of an object; and b. a set of cameras configured to capture a plurality of frames of the surface, wherein a set of images of the plurality of frames includes data conveying a representation of at least a portion of the light pattern and at least a portion of the surface. The scanner further comprises: c. at least one processor in communication with the set of cameras, the at least one processor configured to: i. process the set of images to: A. generate 3D measurements of the surface by processing the representation of at least the portion of the surface in the set of images; and B. generate 3D measurements of at least one light element of the plurality of light elements by processing the representation of at least the portion of the light pattern in the set of images. The at least one processor is further configured to: ii. integrate the 3D measurements of the at least one light element into a linearized point matching system; iii. derive at least one projector parameter by processing the linearized point matching system; and iv. calibrate a reference light element corresponding to the at least one light element and represented by a reference light element equation with the at least one projector parameter to generate a calibrated reference light element equation.

The linearized point matching system may comprise a linearized iterative closest point operation between the 3D measurements of the at least one light element and points of the reference light element and wherein the at least one processor may be configured to integrate the 3D measurements of the at least one light element into the linearized point matching system by being configured to: a. generate at least one matrix based on the 3D measurements of the at least one light element and the points of the reference light element; and b. integrate the at least one matrix into the linearized iterative closest point operation to generate the at least one projector parameter.

The at least one matrix may comprise: a. a covariance matrix of normal vectors and torque vectors of the 3D measurements of the at least one light element relative to the points of the reference light element; and b. a residual vector of the linearized iterative closest point operation.

The at least one projector parameter may comprise at least one of: a. a rotation vector of the 3D measurements of the at least one light element relative to the reference light element; or b. a translation vector of the 3D measurements of the at least one light element relative to the reference light element.

The at least one processor may be configured to derive the at least one projector parameter at least one of: a. at least in part while the at least one processor processes the set of images to generate the 3D measurements of the surface; b. at least in part while the set of cameras captures additional images of the plurality of frames or additional images of the set of images; c. after the at least one processor processes the plurality of frames or the set of images to generate the 3D measurements of the surface; or d. after the set of cameras capture images of the plurality of frames or of the set of images.

The scanner may further comprise causing the at least one processor to generate the 3D measurements of the surface based on least in part on the calibrated reference light element equation.

The object may have a scale artifact fixedly associated with the object and wherein the set of images includes data conveying a representation of at least a portion of the scale artifact. The at least one processor may be further configured to: a. process the set of images to derive at least one derivable camera parameter of the set of cameras by processing dimension information corresponding to the scale artifact and the representation of at least the portion of the scale artifact in the set of images.

The scale artifact may comprise a physical scale element and a nominal scale element, wherein the nominal scale element may provide the dimension information of the physical scale element.

The at least one derivable camera parameter may comprise one or more intrinsic camera parameters.

The set of cameras may comprise a first camera and a second camera and the at least one derivable camera parameter may comprise a camera separation distance between the first camera and the second camera.

The at least one processor may be configured to calibrate one or more calibratable camera parameters of the set of cameras at least in part using the at least one derivable camera parameter.

The one or more calibratable camera parameters may comprise one or more extrinsic camera parameters.

The one or more calibratable camera parameters may comprise one or more intrinsic camera parameters.

The at least one processor may be configured to derive the at least one derivable camera parameter at least one of: a. at least in part while the at least one processor is processing images of the plurality of frames or images of the set of images to generate the 3D measurements of the surface; b. at least in part while the set of cameras are capturing additional images of the plurality of frames or images of the set of images; c. after the at least one processor processes the plurality of frames or the set of images to generate the 3D measurements of the surface; or d. after the set of cameras capture images of the plurality of frames or images of the set of images.

All features of exemplary embodiments which are described in this disclosure and are not mutually exclusive and can be combined with one another. Elements of one embodiment or aspect can be utilized in the other embodiments/aspects without further mention. These and other aspects of this disclosure will now become apparent to those of ordinary skill in the art upon review of a description of embodiments that follows in conjunction with accompanying drawings.

### BRIEF DESCRIPTION OF DRAWINGS

The features of the present disclosure will become more apparent with reference to the following Detailed Description taken in conjunction with the accompanying drawings, wherein like reference numerals denote like elements and in which:

FIG. 1 is a schematic of a three-dimensional (3D) scanning system including a 3D scanner, a scale artifact and a processor circuit in accordance with one embodiment;

FIG. 2 is a schematic of a set of cameras and a projector of the 3D scanner of FIG. 1 in accordance with one embodiment;

FIGS. 3A and 3B are a schematic of a depth of field (DOF), a height and a width of a field of view (FOV) of the 3D scanner of FIG. 1 in accordance with one embodiment as compared to another 3D scanner;

FIG. 4 is a schematic of the scale artifact of FIG. 1 in accordance with one embodiment;

FIG. 5 is a schematic of the processor circuit of FIG. 1 in accordance with one embodiment;

FIG. 6 is a flowchart of a 3D scanning procedure performed using the 3D scanning system of FIG. 1 in accordance with one embodiment;

FIG. 7 is a schematic representation of a camera model in accordance with one embodiment;

FIG. 8 is a schematic representation of a lens distortion model in accordance with one embodiment;

FIG. 9 is a plot representation of a translation vector t_{sc2} between a first camera origin and a second camera origin of the 3D scanner of FIG. 1;

FIG. 10 is a flowchart of a calibrate camera parameters procedure performed at the processor circuit of FIG. 5 in accordance with one embodiment;

FIG. 11 is a flowchart of a calibrate projector parameters procedure performed at the processor circuit of FIG. 5 in accordance with one embodiment;

FIG. 12 is a schematic of a projector light model in accordance with one embodiment;

FIG. 13 is a schematic of reference light planes as compared to actual light planes projected by a projector of the 3D scanner of FIG. 1;

FIG. 14 is a schematic of depth bins used to voxelize the DOF of the 3D scanner of FIG. 1; and

FIG. 15 is a schematic of height bins used to voxelize heights of the FOV of the 3D scanner of FIG. 1.

FIGS. 16A and 16B are schematic representations of a small angle approximation of a rotation and translation of an actual light plane relative to a reference light in accordance with one embodiment;

In the drawings, embodiments are illustrated by way of example only. It is to be expressly understood that the description and drawings are only for purposes of illustrating certain embodiments and are an aid for understanding. They are not intended to be a definition of the limits of the claimed subject matter.

### DETAILED DESCRIPTION

A detailed description of one or more specific embodiments of the invention is provided below along with accompanying Figures that illustrate principles of the invention. The invention is described in connection with such embodiments, but the invention is not limited to any specific embodiment. In particular, the present description presents, amongst other embodiments, some embodiments in which a three-dimensional (3D) scanning system includes a 3D scanner, a processor circuit and a scaling artifact. The 3D scanner may include a set of cameras and a projector. The processor circuit may include code directing a processor to utilize dimension information of the scaling artifact to derive at least one derivable parameter associated with the set of cameras. The at least one derivable parameter may then be used to calibrate 3D measurements of a surface of a target object scanned by the 3D scanner, as well as other intrinsic and extrinsic camera parameters associated with the set of cameras. In some embodiments, the at least one derivable parameter may specifically comprise a separation distance between a first camera and a second camera of the set of cameras. In other embodiments, the at least one derivable parameter may comprise 3D measurements corresponding to the scaling artifact.

Further, the present description presents, amongst other embodiments, some embodiments in which the processor circuit also include code directing the processor to generate 3D measurements of at least one light element projected by the projector and generate at least one projector parameter based on the 3D measurements of the at least one light element. The at least one projector parameter can be used to calibrate a reference light element (which may specifically be a reference light element equation in some embodiments) representing the at least one light element. The calibrated reference light element can be used as a calibrated baseline orientation of the at least one light element and can, in turn, be used to calibrate 3D measurements of the surface of the target object generated by the 3D scanner. In some embodiments, to enable determination of the at least one projector parameter during a 3D scanning procedure, the processor circuit may also include code directing the processor to voxelize a field of view (FOV) of the 3D scanner and to generate a plurality of centroids each representing a collapsed version of certain 3D measurements of the at least one light element. The at least one projector parameter can be generated based on the plurality of centroids associated with the at least one light element rather than all 3D measurements of the at least one light element.

Those skilled in the art would appreciate that the embodiments described are being provided only for the purpose of illustrating the inventive principles and should not be considered as limiting. In particular, alternate embodiments will become apparent to those skilled in the art in view of the present description. Numerous specific details are set forth in the following description in order to provide a thorough understanding of the invention. These details are provided for the purpose of describing non-limiting examples and the invention may be practiced without some or all of these specific details. For the purpose of clarity, technical material that is known in the technical fields related to the invention has not been described in great detail so that the invention is not unnecessarily obscured.

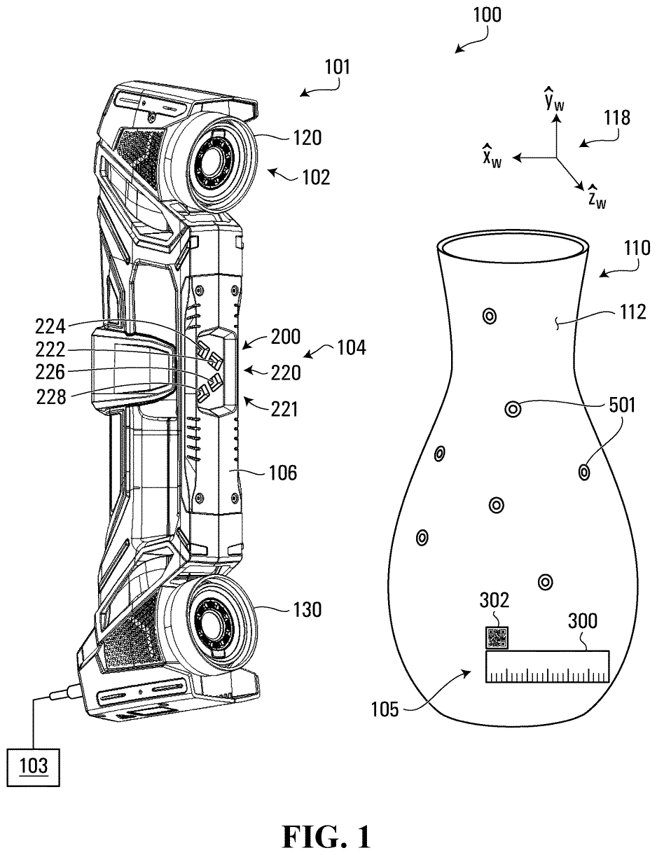

Referring to FIG. 1, a three-dimensional (3D) scanning system in accordance with one embodiment is generally shown at 100. In the embodiment shown, the 3D scanning system 100 includes a 3D scanner 101, a processor circuit 103, and a scale artifact 105.

### 3D Scanner 101

The 3D scanner 101 may be implemented as a handheld 3D scanner and may include a set of cameras 102 and at least one projector 104 mounted to a rigid frame structure within a housing 106. The set of cameras 102 and the projector 104 may be in communication with the processor circuit 103 via a wired connection and/or over a wireless network (not shown). The scanner 101 is generally configured to capture frames (also referred to as images) of a surface 112 of a target object 110 and generate 3D measurements corresponding to features (also referred to as points) on the surface 112 based on the frames, which may be used to generate a 3D representation of the target object 110 (e.g., a 3D point cloud and/or a 3D polygonal mesh generated from the 3D point cloud). These features on the surface 112 are located at positions within a physical world reference frame 118

$$( [ \begin{matrix}{\hat{x}}_{w} \\ {\hat{y}}_{w} \\ {\hat{z}}_{w}\end{matrix} ] ) .$$

The physical world reference frame 118 may be defined relative to the scale artifact 105 in some embodiments.

### Set of Cameras 102

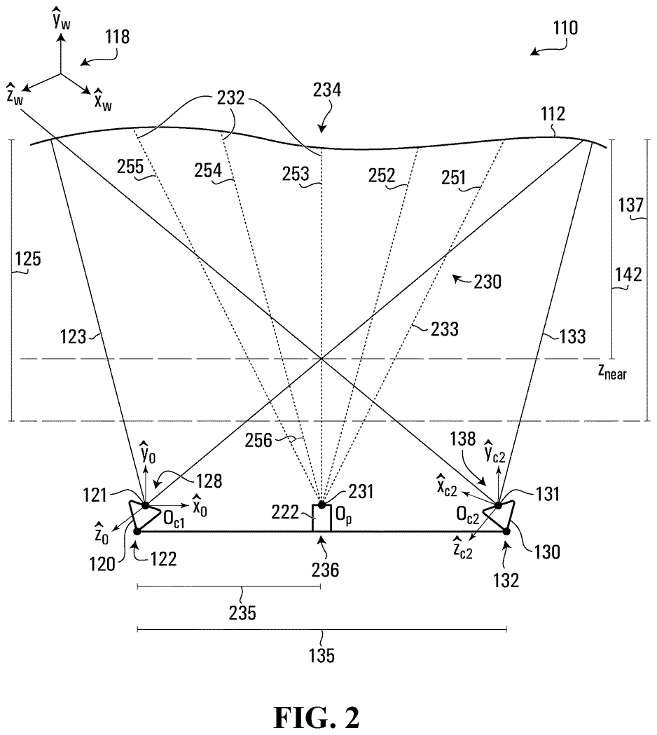

In the embodiment shown in FIGS. 1 and 2, the set of cameras 102 includes a first camera 120 and a second camera 130; however, in other embodiments, the set of cameras 102 may include fewer or additional cameras. The first and second cameras 120 and 130 may be mounted to the rigid frame structure within the housing 106 to define a baseline (between the first camera 120 and the second camera 130) of the scanner 101. The first and second cameras 120 and 130 capture a first image and a second image respectively image of portions of the surface 112 of the target object 110 at a same time point (tₙ), or at substantially the same time point, from different perspectives. The phrases “a same time point”, “tₙ”, and/or “a particular tₙ” as used herein generally means time points where there is no relative displacement (or negligible relative displacement) between the target object 110 and the set of cameras 102. For example, the first image may be captured by the first camera 120 at a first time point and the second image may be captured by the second camera 130 at a second time point; the first and second time points may be considered “the same time point” or “a particular tₙ” when there is no (or negligible) relative displacement between the target object 110 and the set of cameras 102 as between the first and second time points. The first and second time points may be simultaneous or substantially simultaneous. Alternatively, the first and second time points may also be sequential, so long as there is no (or negligible) relative displacement between the set of cameras 102 and the target object 110 as between the first and second time points. The first and second images may be processed by the processor circuit 103 to determine 3D measurements of features (or points) of the surface 112 using triangulation calculations and bundle adjustment calculations (some of which are described below and others are known to those skilled in the art) based on relative geometry of the first and second cameras 120 and 130, intrinsic and extrinsic parameters of the first and second camera 120 and 130, and relative geometry of the light pattern projected by the at least one projector 104. Accordingly, the scanner 101 generally comprises a stereo-view scanner, a multi-view scanner or other term known to those skilled in the art.

The first and second cameras 120 and 130 may be monochrome cameras, visible color spectrum cameras, infrared cameras, or near infrared cameras or other types of cameras known to those skilled in the art. The type of the first and second cameras 120 and 130 may generally correspond to, and depend on, a type of light projected by the set of projectors 104. For example, in embodiments where the set of projectors 104 project visible light, the first and second cameras 120 and 130 may be monochrome or visible colour cameras; however, in embodiments where the projector 104 projects infrared or near infrared light, the first and second cameras 120 and 130 may be monochrome, infrared or near-infrared cameras.

Still referring to FIGS. 1 and 2, the first camera 120 is mounted to the rigid frame structure within the housing 106 at a first camera position 122 and is orientated in a first camera orientation

$${O}_{c 1} = [ \begin{matrix}{\hat{x}}_{c 1} \\ {\hat{y}}_{c 1} \\ {\hat{z}}_{c 1}\end{matrix} ]$$

at a first camera origin 121 which can define a first camera field-of-view (FOV) 123. In some embodiments, the first camera 120 may be an origin sensor and the first camera origin 121 may be an origin point of the scanner 101, and the first camera orientation O_{c1} may generally define a sensor reference frame 128

$$[ \begin{matrix}{\hat{x}}_{o} \\ {\hat{y}}_{o} \\ {\hat{z}}_{o}\end{matrix} ]$$

shown in FIG. 2. Points or features identified in the world reference frame 118 may be transformed into the sensor reference frame 128 with a rotation matrix Rₒ and a translation vector tₒ which combine to form extrinsic parameters Mₒ of the origin sensor (e.g., the first camera 120) or the origin point (e.g., the first camera origin 121 of the first camera 120) of the scanner 101 describing a pose of the origin sensor or the origin point of the scanner 101 in the world reference frame 118 as described below.

In other embodiments, the origin sensor or the origin point of the scanner 101 which defines the sensor reference frame 128 may comprise a projector (e.g., a projector 222 described below) of the at least one projector 104 and/or an arbitrary point along the baseline between the first and second cameras 120 and 130. In yet some other embodiments, the origin point of the scanner 101 may instead comprise an arbitrary point slightly offset from the baseline of the scanner 101 in the \hat{x}ₒ, ŷₒ, or \hat{z}ₒ direction, such as by between approximately 0.1 cm and 10 cm. In such embodiments, the first camera orientation O_{c1} may be different from the scanner reference frame 128 at the origin point and may need to be defined relative to the sensor reference frame 128 for some calibration procedures described below, in which case

$${O}_{c 1} = [ \begin{matrix}{x}_{o} \\ {y}_{o} \\ {z}_{o}\end{matrix} ] .$$

However, in such embodiments, as the first camera orientation O_{c1} is often a camera parameter which is initially determined using the first image captured by the first camera 120, the first camera orientation O_{c1} may initially be defined in a first camera reference frame, in which case

$${O}_{c 1} = [ \begin{matrix}{\hat{x}}_{c 1} \\ {\hat{y}}_{c 1} \\ {\hat{z}}_{c 1}\end{matrix} ]$$

(not shown). In such embodiments, points or features identified in the first camera reference frame may then be transformed into the sensor reference frame 128 with a rotation matrix R_{c1} and a translation vector t_{c1} which combine to define stereo extrinsic parameters M_{c1} of the first camera 120 describing a pose of the first camera 120 in the sensor reference frame 128 and relative to the origin point (described below). In some embodiments described below, the first camera 120 comprises the origin sensor and the first camera origin 121 comprises the origin point of the scanner 101 and the first camera reference frame is equivalent to, and defines, the sensor reference frame 128.

The second camera 130 is mounted to the rigid frame structure within the housing 106 at a second camera position 132 and is orientated in a second camera orientation O_{c2} which may define a second camera FOV 133. The second camera orientation O_{c2} may be different from the scanner reference frame 128 at the origin point and may need to be defined relative to the sensor reference frame 128 for some calibration procedures described below, in which case

$${O}_{c 2} = [ \begin{matrix}{x}_{o} \\ {y}_{o} \\ {z}_{o}\end{matrix} ] .$$

However, as the second camera orientation O_{c2} is often a camera parameter which is initially determined using the second image captured by the second camera 130 (described below), the second camera orientation O_{c2} may initially be defined in a second camera reference frame 138, in which case

$${O}_{c 2} = [ \begin{matrix}{\hat{x}}_{c 2} \\ {\hat{y}}_{c 2} \\ {\hat{z}}_{c 2}\end{matrix} ] .$$

In such embodiments, points or features identified in the second camera reference frame 138 may then be transformed into the sensor reference frame 128 with a rotation matrix R_{c2} and a translation vector t_{c2} which combine to define stereo extrinsic parameters M_{c2} of the second camera 130 describing a pose of the second camera 130 in the sensor reference frame 128 and relative to the origin sensor or the origin point (described below).

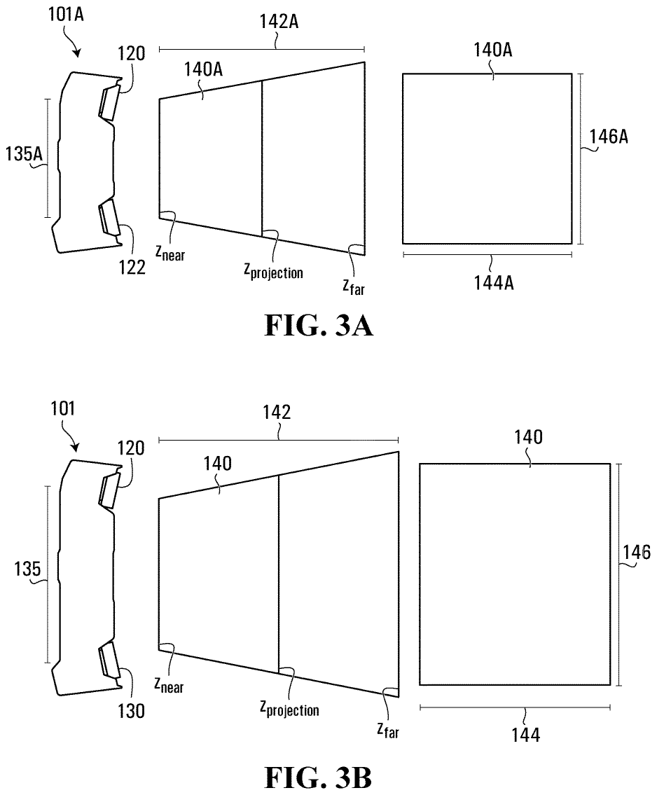

The first and second camera positions 122 and 132 (and in particular the first and second camera origins 121 and 131) may be separated by the camera separation distance 135 along the baseline between the first and second cameras 120 and 130 (shown in FIGS. 2, 3A and 3B). In the embodiment shown, the camera separation distance 135 is approximately 317 mm; however, in other embodiments, the camera separation distance 135 may range between approximately 120 mm and 600 mm.

Generally, the camera separation distance 135, the first camera orientation O_{c1}, and the second camera orientation O_{c2} are configured such that the first and second camera FOVs 123 and 133 at least partially overlap. As a result, a first image captured by the first camera 120 and a second image captured by the second camera 130 for a particular tₙ are spatially neighboring images. The phrase “spatially neighboring images” as used herein means images which include a portion of overlap as therebetween. This portion of overlap enables a same feature (or point) to be identified and matched as between different images of the spatially neighboring images. This portion of overlap may include representations of a same portion of the surface 112, representations of a same portion of the scale artifact 105, and/or representations of at least some of visual targets 501. For a particular tₙ, a first image captured by the first camera 120 and a second image captured by the second camera 130 are generally spatially neighboring images due to the at least partial overlap as between the first camera FOV 123 and the second camera FOV 133 described above. Over different time points of a particular 3D scanning procedure, e.g., t₁, t₂, [. . .] tₙ, [. . .], t_{end}, different first images captured by the first camera 120 (and/or different second images captured by the second camera 130) may also be spatially neighboring images, depending on a pose of the scanner 101 relative to the target object 110 in the world reference frame 118 (i.e., Mₒ as described below) for each of the different time points.

The two different images captured for a particular tₙ by the first and the second cameras 120 and 130 may collectively be referred to as a “frame” for that particular tₙ. The phrase “spatially neighboring frames” as used herein means frames (each frame including at least two images from slightly different viewpoints as described above) which include a portion of overlap as therebetween. This portion of overlap again enables a same feature (or point) to be identified and matched as between different frames. This portion of overlap may include representations of a same portion of the surface 112, representations of a same portion of the scale artifact 105, and/or representations of at least some of the visual targets 501. Over different time points of a particular 3D scanning procedure, e.g., t₁, t₂, [. . .], tₙ, [. . .], t_{end}, different frames captured by the first and second cameras 120 and 130 may be spatially neighboring frames, depending on a pose of the scanner 101 relative to the target object 110 in the world reference frame 118 (i.e., Mₒ, as described below) for each of the different time points. The first and second cameras 120 and 130 may capture different sets of spatially neighboring frames, such as a first set of spatially neighboring frames over a first set of time points (e.g., t₁, t₂, t₃, t₄) during a particular 3D scanning procedure, a second set of spatially neighboring frames over a second set of time points (e.g., t₅, t₆, t₇, t₈), etc. Such spatially neighboring frames may include a set of images which include representations of a portion of the surface 112, representations of the scale artifact 105 and/or representations of at least some of the visual targets 501. Some images within the set of images may be spatially neighboring images; however, some images within the set of images may not be spatially neighboring images (such as images captured by the first camera 120 over different time points for example). Additionally, different sets of spatially neighboring frames may each include different sets of images; for example, the first set of spatially neighboring frames may include a first set of images, the second set of spatially neighboring images may include a second set of images, etc.

The phrase “camera FOV” as used herein generally means an area or an angular span over which a particular camera (e.g., the first or second cameras 120 or 130) can capture an observable world. The phrase “camera DOF” as used herein generally means a depth over which a particular camera (e.g., the first or second cameras 120 or 130) can capture an object in an image above a given resolution. In the context of a camera used in a 3D scanner, this given resolution is typically a resolution required to extract, match and/or generate 3D measurements for features of the object represented in the image captured by that particular camera. An area of the first and second camera FOVs 123 and 133 and a depth of the first and second camera DOFs 125 and 137 may vary depending on characteristics associated with the first and second cameras 120 and 130 as known to those skilled in the art. For example, the DOF of a camera may increase as an aperture of a camera decreases. Further, the area of the FOV of a camera may increase, while the DOF may increase, when the camera utilizes a lens with a reduced focal length (e.g., wide-angle lenses). Further still, the size of the FOV of a camera may increase when an image sensor of a camera increases in size.

Referring to FIGS. 2, 3A and 3B, the area of the first and second camera FOVs 123 and 133, the depth of the first and second camera DOFs 125 and 137, and the camera separation distance 135 may combine to affect an area of a scanner FOV 140 and an overall depth of a scanner DOF 142 of the scanner 101. The phrase “scanner FOV” as used herein generally means an area or an angular span over which a processor circuit (e.g., the processor circuit 103) of the 3D scanner can substantially accurately determine 3D measurements of features on a surface of an object based on images of the object captured by cameras (e.g., the first or second cameras 120 or 130) of the 3D scanner. The phrase “scanner DOF” as used herein generally means a depth over which the processor circuit can substantially accurately determine 3D measurements of features on a surface of an object based on images of the object captured by the cameras. As the first and second camera FOVs 123 and 133 and DOFs 125 and 137 increase, the scanner FOV 140 and DOF 142 may similarly increase. The camera separation distance 135 may also affect the scanner FOV 140 and DOF 142. For example, when the camera separation distance 135 increases, the scanner DOF 142 may increase as the first and second images captured by the first and second cameras 120 and 130 for a particular tₙ may have a larger disparity for a particular feature which can be used to determine 3D measurements of that particular feature.

As a specific example, a scanner 101A having a camera separation distance 135A of approximately 180 mm between the first and second cameras 120 and 130 is shown in FIG. 3A. The scanner 101A may have a scanner DOF 142A including a zₙₑₐᵣ of approximately 250 mm, a z_{projection} of approximately 300 mm, and a z_{far} of approximately 450 mm, and a scanner FOV 140A at z_{projection} with a width 144A of approximately 310 mm and a height 146A of approximately 350 mm. The z_{projection} is generally a nominal distance where a manufacturer of the scanner 101A or 101 expects an operator to scanner a target object (e.g., the target object 110) at. In contrast, the scanner 101 having the camera separation distance 135 of approximately 317 mm is shown in FIG. 3B. The scanner 101 may have the scanner DOF 142 including a zₙₑₐᵣ of approximately 350 mm, a z_{projection} of approximately 1200 mm, and a z_{far} of approximately 1500 mm, and the scanner FOV 140 at z_{projection} with a width 144 of approximately 1200 mm and a height 146 of approximately 1200 mm at z_{projection}. This increase in the scanner DOF 142 and scanner FOV 140 may allow the scanner 101 to be positioned further away from a surface of a target object when compared to scanner 101A, and allow the scanner 101 to perform a 3D scan of larger target objects.

### At Least One Projector 104

Referring back to FIG. 1, in the embodiment shown, the at least one projector 104 comprises a set of projectors 200 including a top set of projectors 220 and a bottom set of projectors 221. The top set of projectors 220 includes a first top projector 222 and a second top projector 224, while the bottom set of projectors 221 includes a first bottom projector 226 and a second bottom projector 228. In the embodiment shown, the set of projectors 200 are be mounted to the rigid frame structure within the housing 106 slightly offset from the baseline between the first and second cameras 120 and 130; however, in some embodiments, at least one projector 222, 224, 226 and 228 may be mounted to the rigid frame structure within the housing 106 on the baseline. However, in some embodiments, the at least one projector 104 may only comprise a single projector of the projectors 222, 224, 226, and 228. Features of the at least one projector 104 are explained with reference to only a single projector 222 in FIG. 2 and in the description below for clarity; however, those skilled in the art will recognize that the below description would also be similarly applicable to any of the projectors 224, 226 and 228 in embodiments of the scanner 101 including more than one projector.

Referring now to FIG. 2, the projector 222 is a multi-line projector projecting a plurality of light planes 230 from a projector origin 231 of the projector 222 onto the surface 112 of the target object 110. When the light planes 230 contact the surface 112, the light planes 230 resolve as a corresponding plurality of light lines 232 forming a light pattern 234 on the surface 112. Representations of the light lines 232 (or portions thereof) reflected on the surface 112 may be included in images captured by the first and second cameras 120 and 130 and may be transmitted to the processor circuit 103. The processor circuit 103 may utilize the representations of the light lines 232 in the images to assist in determining 3D measurements of the surface 112; in particular, representations of the light lines 232 in the images (as distorted by contours of the surface 112) may function as features to be extracted from the images and matched between different first and second images of a same frame captured by the first and second cameras 120 and 130 for a particular tₙ. In other embodiments, the projector 222 may instead comprise alternative multi-element projectors, such as a multi-dot projectors projecting a plurality of dots for example; in such embodiments, the light planes may instead comprise light columns.

The projector 222 is mounted to the rigid frame structure within the housing 106 at a projector position 236 and is (such as at the projector origin 231) orientated in a projector orientation Oₚ. The projector orientation Oₚ may be defined relative to the sensor reference frame 128 (i.e., relative to the first camera origin 121 of the first camera 120) in images captured by the first camera 120, in which case

$${O}_{p} = [ \begin{matrix}{x}_{o} \\ {y}_{o} \\ {z}_{o}\end{matrix} ] .$$

The projector orientation Oₚ may also be defined relative to the second camera reference frame 138 (i.e., relative to the second camera origin 131 of the second camera 130) in images captured by the second camera 130, in which case

$${O}_{p} = [ \begin{matrix}{x}_{c 2} \\ {y}_{c 2} \\ {z}_{c 2}\end{matrix} ] .$$

Other embodiments, the projector orientation Oₚ can generally define the FOP 233 over which the projector 222 projects the light planes 230. An area and a depth of the projector FOP 233 may vary depending on characteristics associated with a light source of the projector 104. For example, the depth of a FOP of a projector may increase as a power of the light source increases. Additionally, and the area of a FOP of a projector may increase as a number of light planes projected by the projector increases and/or when the inter-beam angle increases.

The projector position 236 may be separated from the first camera position 122 by a projector separation distance 235. In the embodiment shown, the projector separation distance 235 is approximately 158 mm; however, in other embodiments, the projector separation distance 235 may range between approximately 40 mm and 250 mm.

As briefly described above, the projector 222 may project the light planes 230 as visible light, infrared light, or near-infrared light. In the embodiment shown FIG. 2, the plurality of light planes 230 projected by the projector 222 comprises five light planes, including a first light plane 251, second line plane 252, a third light plane 253, a fourth light plane 254 and a fifth light plane 255; however, in other embodiments, the light planes 230 may comprise anywhere between two and 200 light planes, and may comprise three light planes, five light planes, seven light planes, nine light planes, 11 light planes, 15 light planes, 19 light planes, 33 light planes, 59 light planes, 65 light planes, or 99 light planes for example. Each of the first to fifth light planes 251-255 may be defined by a reference light plane equation (shown in equation (1)) generally defining a position of the light plane within the sensor reference frame 128.

$$A {x}_{o} + B {y}_{0} + C {z}_{o} + {d}_{o} = 0 \qquad ( 1 )$$

The reference light plane equation (1) may be used to set a reference light plane equation (described below). The equation (1) above is provided as an example only. In some embodiments, each of the first to fifth light planes 251-255 may be comprised of multiple sequential planes and may be a sequence of multiple instances of the equation (1) above. This sequence of multiple instances of the equation (1) above can be used to compensate for curvature in the corresponding light plane.

The projector position 236 and the projector orientation Oₚ are configured such that both the first and second camera FOVs 123 and FOV 133 may at least partially overlap a same portion of the projector FOP 233. As a result, a first image captured by the first camera 120 and a second image captured by the second camera 130 for a particular tₙ (i.e., collectively, a frame for that particular tₙ) may both include representation of at least one same light line of the light lines 232. As described above, representation of this at least one same light line may be used as a feature to be extracted and matched as between the first image and the second image for that particular tₙ.

Referring briefly back to FIGS. 2 and 3B, the area and the depth of the projector FOP 233 of the projector 222 combines with the first and second camera DOFs 125 and 137, and an area of the first and second camera FOVs 123 and 133 of the first and second cameras 120 and 130 to affect the overall scanner FOV 140. For example, as the projector FOP 233 increases, the scanner FOV 140 may also increase so long as the first and second camera FOVs 123 and 133 can accommodate such increase.

### Pre-Operation Calibration Procedures

Referring to FIG. 1, first camera orientation O_{c1} defining the sensor reference frame 128

$$[ \begin{matrix}{\hat{x}}_{o} \\ {\hat{y}}_{o} \\ {\hat{z}}_{o}\end{matrix} ]$$

and the equivalent first camera reference frame

$$[ \begin{matrix}{\hat{x}}_{c 1} \\ {\hat{y}}_{c 1} \\ {\hat{z}}_{c 1}\end{matrix} ] ,$$

the second camera orientation O_{c2} defining the second camera reference frame 138

$$[ \begin{matrix}{\hat{x}}_{c 2} \\ {\hat{y}}_{c 2} \\ {\hat{z}}_{c 2}\end{matrix} ] ,$$

the projector orientation Oₚ relative to the sensor reference frame 128 and/or the second camera reference frame 138, the camera separation distance 135, the projector separation distance 235 and the light plane models equations of each of the light planes 230 relative to the sensor reference frame 128 and/or the second camera reference frame 138 may be utilized in various triangulation calculations and bundle adjustment calculations (some of which are described below, and others are known to those skilled in the art) to determine 3D measurements of features on the surface 112 of the target object 110. Accordingly, these parameters may be initially factory calibrated when the scanner 101 is manufactured by the manufacturer and/or returned to the manufacturer for service. However, during the lifetime of the scanner 101 and while the scanner 101 is in the possession of an operator, the first camera 120, the second camera 130, and the projector 222 may move or shift relative to each other, such as due to impact forces on the scanner 101, mechanical stresses on the scanner 101, changes in temperature, changes in altitude, or other environmental factors such as humidity, dust or debris. Relative shifts or movements of the first camera 120, the second camera 130, and the projector 222 may cause corresponding changes in one or more of the camera separation distance 135, the projector separation distance 235, the first camera orientation O_{c1}, the second camera orientation O_{c2}, the projector orientation Oₚ, and/or the reference light plane equations of each of light planes 230, as well as other changes in different camera parameters of the first and second cameras 120 and 130, and different projector parameters of the projector 222. It may be necessary to re-calibrate one or more of the different camera parameters of the first and second cameras 120 and 130 and different projector parameters of the projector 222 during the lifetime of the scanner 101 and while the scanner 101 is in the possession of an operator.

Calibration of camera parameters of the first and second cameras 120 and 130 and of projector parameters of the projector 222 may sometimes involve a pre-operation calibration procedure of the scanner 101. The phrase “pre-operation calibration procedure” as used herein generally means performing at least one dedicated pre-operation calibration procedure with the scanner 101 prior to performing a 3D scanning procedure with the scanner 101 to obtain the 3D measurements of the surface 112 of the target object 110. The dedicated calibration procedure may involve capturing a plurality of calibration frames of a calibration object separate from the target object 110. For example, the calibration object may be a calibration plate having a substantially flat calibration surface including a plurality of calibration position markers positioned in a pre-defined configuration thereon. The dedicated calibration procedure may also involve capturing a plurality of calibration frames of the target object 110 associated with a reference artifact, but where the plurality of calibration frames are not used to generate any 3D measurements of the surface 112 of the target object 110.

However, such pre-operation calibration procedures may be inconvenient and onerous for an operator and may be susceptible to operator error in situations where the operator does not scan the reference artifact or the calibration object properly or completely. Additionally, for scanners having a large FOV or a deep DOF, it may be impractical to manufacture a separate calibration object capable of fully calibrating the scanner due to a required size of such calibration objects. For example, for the scanner 101 having the scanner DOF 142 of between 350 mm and 1500 mm, and the FOV 140 having the width 144 of approximately 1200 mm at z_{projection} and the height 146 of approximately 1200 mm at z_{projection}, a calibration plate may need to have a corresponding height of approximately 1200 mm and a width of approximately 1200 mm commensurate with the width 144 and the height 146 of the scanner FOV 140 for example. Such a large calibration plate may be impractical to manufacture, store and transport with the scanner 101. More specifically, as described above, the scanner 101 may be a portable handheld scanner adapted to be transported to different scanning locations to scan different target objects. Due to potential changes in environmental conditions at each scanning locations, the scanner 101 may need to be calibrated at each different scanning location. A large 1200 mm×1200 mm calibration plate which is a single unitary piece may not fit within a carrying case of the scanner 101 and may be too heavy for easy transport with the handheld scanner 101.

### Scale Artifact 105

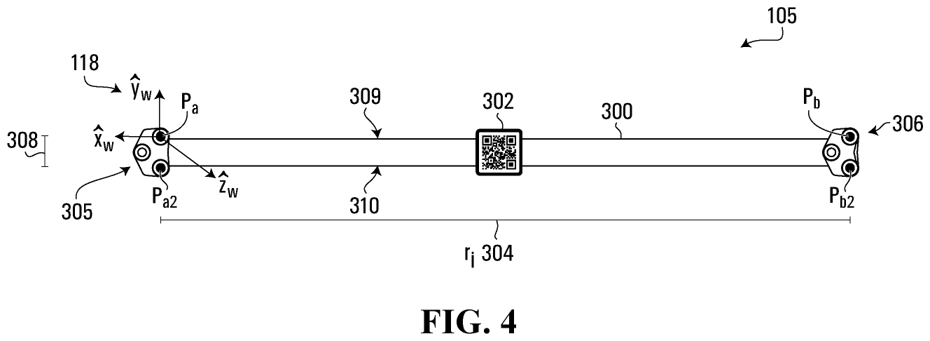

Referring now to FIGS. 1 and 4, in the embodiment shown, calibration of camera parameters of the first and second cameras 120 and 130 and/or of projector parameters of the projector 222 may instead be assisted by the scale artifact 105. Very generally, the scale artifact 105 functions to provide a physical indication of actual linear scale which may be injected into certain bundle adjustment operations as described below. This linear scale may be used to derive certain camera parameters, and may specifically be used to derive the camera separation distance 135 (described below). The derived camera separation distance 135 may then be used in certain bundle adjustment operations to minimize error associated with other camera parameters and/or projector parameters. Representations of the scale artifact 105, or a portion of thereof, may be included in images captured by the first and second cameras 120 and 130 transmitted to the processor circuit 103. Representations of the scale artifact 105 in the images may be used to derive the linear scale. Representations of the scale artifact 105 in the images may function as features to be extracted from the images and matched between spatially neighboring images or spatially neighboring frames.

As described below, utilizing the scale artifact 105 may also enable concurrent calibration procedures and/or post-operation calibration procedures to be performed by the processor circuit 103. The phrase “concurrent calibration procedure” as used herein generally means performing at least one calibration procedure of at least one camera parameter and/or at least one projector parameter with the processor circuit 103 while performing a 3D scanning procedure with the scanner 101 to obtain 3D measurements of the surface 112 of the target object 110. This concurrent calibration procedure may be performed while the first and second cameras 120 and 130 are actively capturing the spatially neighboring images and/or the spatially neighboring frames which will be processed to generate the 3D measurements of the surface 112. This concurrent calibration procedure may also be performed while the processor circuit 103 is processing the captured spatially neighboring frames to determine the 3D measurements of the surface 112. The phrase “post-operation calibration procedure” as used herein generally means performing at least one calibration procedure of at least one camera parameter and/or at least one projector parameter with the processor circuit 103 after performing the 3D scanning procedure with the scanner 101. This post-operation calibration procedure may be performed after the first and second cameras 120 and 130 have finished capturing the spatially neighboring images and/or the spatially neighboring frames which will processed to generate the 3D measurements of the surface 112. However, this post-operation calibration procedure may be performed while the processor circuit 103 is still processing the captured spatially neighboring images and/or the captured spatially neighboring frames. Further, as described below, the concurrent calibration procedure and the post-calibration procedure may both be performed using the same spatially neighboring images and/or the same spatially neighboring frames which are processed to generate the 3D measurements of the surface 112, rather than any calibration images or calibration frames specifically captured by the first and second cameras 120 and 130 for the purpose of the calibration procedures.

Referring still referring to FIGS. 1 and 4, the scale artifact 105 comprises a physical scale element 300 configured to be fixedly associated with the target object 110. The phrase “fixedly associated” as used herein generally means associated without any relative movement of the associated elements. For example, the physical scale element 300 may be affixed to a particular position on the surface 112 such that there is no relative movement of the physical scale element 300 and the target object 110. Alternatively, the physical scale element 300 may be placed at a fixed scale position adjacent to, in front of, or proximate to a fixed object position of the target object 110. The fixed scale position and the fixed object position may be static, such that there is no relative movement of the physical scale element 300 and the target object 110.

The physical scale element 300 generally provides a physical indication of scale in the images captured by the first and second cameras 120 and 130 and may be used to orientate the world reference frame 118 when analyzing the images in some embodiments. In this respect, the physical scale element 300 has a first end 305 including physical scale features Pₐ and Pₐ₂ and a second end 306 including physical scale features P_{b} and P_{b2}. The physical scale element 300 further includes a top end 309 and a bottom end 310.

The physical scale features Pₐ and P_{b} may form a first set of physical scale features, while the physical scale features Pₐ₂ and P_{b2} may form a second set of physical scale features. Each set of the physical scale features Pₐ, P_{b} and Pₐ₂, P_{b2} may be used to determine an actual physical measurement of the physical scale element 300. In some embodiments and as described below, any two physical scale features may form a set of physical scale features to be analyzed together. Further, although the first and second sets of physical scale features Pₐ, P_{b} and Pₐ₂, P_{b2} are shown in FIG. 4 as being a combination of two physical scale features, in other embodiments, a particular set of physical scale features may include three physical scale features, four physical scale features, five physical scale features etc. Further, in some embodiments, the physical scale element 300 may include further or alternative sets of physical scale features which may be used to determine an actual physical measurement of the physical scale element 300.

In the embodiment shown, the first physical scale feature Pₐ may be used to set an origin of the world reference frame 118

$$[ \begin{matrix}{\hat{x}}_{w} \\ {\hat{y}}_{w} \\ {\hat{z}}_{2}\end{matrix} ] .$$

The first and second physical scale features Pₐ and P_{b} may be located at a same y_{w} coordinate and a same z_{w} coordinate of the world reference frame 118 and may differ with respect to the x_{w} coordinate, whereby a separation distance rᵢ between the x_{w} coordinates of Pₐ and P_{b} may represent a physical linear length 304 between Pₐ and P_{b} in the world reference frame 118. In other embodiments, the physical scale features Pₐ and P_{b} may be disassociated from the origin of the world reference frame 118. In such embodiments, the separation distance rᵢ may more generally represent an Euclidean distance between the

$${P}_{wa} = [ \begin{matrix}{x}_{w a} \\ {y}_{w a} \\ {z}_{w a}\end{matrix} ]$$

coordinates of Pₐ and the

$${P}_{wb} = [ \begin{matrix}{x}_{w b} \\ {y}_{w b} \\ {z}_{w b}\end{matrix} ]$$

coordinates of P_{b} within the world reference frame 118, and but may still represent the physical linear length 304 of the physical scale element 300. In other embodiments, an Euclidean distance between the

$${P}_{wa} = [ \begin{matrix}{x}_{w a} \\ {y}_{w a} \\ {z}_{w a}\end{matrix} ]$$

coordinates of Pₐ and the

$${P}_{w a 2} = [ \begin{matrix}{x}_{w a 2} \\ {y}_{w a 2} \\ {z}_{w a 2}\end{matrix} ]$$

coordinates of Pₐ₂ may represent a physical linear height 308 of the physical scale element 300. Alternatively and/or additionally, an Euclidean distance between the

$${P}_{w a 2} = [ \begin{matrix}{x}_{w a 2} \\ {y}_{w a 2} \\ {z}_{w a 2}\end{matrix} ]$$

coordinates of Pₐ₂ and the

$${P}_{wb} = [ \begin{matrix}{x}_{wb} \\ {y}_{wb} \\ {z}_{wb}\end{matrix} ]$$

coordinates of P_{b} may represent an actual physical diagonal measurement (not shown) of the physical scale element 300.

Representations of the physical scale element 300 and the physical scale features Pₐ, P_{b}, Pₐ₂, P_{b2} may be included in certain images captured by the first and second cameras 120 and 130 and may be transmitted to the processor circuit 103. The processor circuit 103 may analyze images captured by the first and second cameras 120 and 130 to determine whether there is sufficient representation of the physical scale element 300 in those images and may cause a user interface (not shown) associated with the scanning system 100 to provide an indication to the operator when the physical scale element 300 is sufficiently represented and/or when more frames including representations of the physical scale element 300 are required. For example, the processor circuit 103 may determine that the physical scale element 300 is sufficiently represented when the images captured by the first and second cameras 120 and 130 include a representation of at least one set of the physical scale features (e.g., a feature corresponding to the physical scale feature Pₐ and another feature corresponding to the physical scale feature P_{b}). In other embodiments, the processor circuit 103 may instead require that the images captured by the first and second cameras 120 and 130 include a representation of at least two sets or at least three sets of the physical scale features.

In the embodiment shown in FIG. 4, the physical scale element 300 comprises a physical ruler; however, in other embodiments, the physical scale element 300 may comprise a scaling rod, at least two scaling targets, and/or other indications of physical linear scale known to those skilled in the art.

In some embodiments, including the one shown in FIG. 4, the scale artifact 105 further comprises a nominal scale element 302 associated with the physical scale element 300. The nominal scale element 302 may be configured to provide dimension information of the physical scale element 300. This dimension information may specifically comprise the separation distance rᵢ between a particular set of first and second physical scale features (e.g., the separation distance rᵢ between the physical scale features Pₐ, P_{b} representing the physical linear length 304; the separation distance between the physical scale features Pₐ, Pₐ₂ representing the physical linear height 308). In embodiments where the physical scale element 300 includes more than one set of the physical scale features, the nominal scale element 302 may include separate dimension information associated with each set of physical scale features. For example, the nominal scale element 302 may be associated with both the separation distance rᵢ representing the physical linear length 304, the separation distance representing the physical linear height 308, and the separation distance representing the physical diagonal measurement. The nominal scale element 302 allows the processor circuit 103 to independently retrieve the dimension information of the physical scale element 300 without requiring the dimension information to be hard-coded into calibration procedures performed by the processor circuit 103 or otherwise to be entered by a user (described below). Further, a combination of a particular physical scale element 300 associated with a particular nominal scale element 302 forming a particular scale artifact 105 may also allow different scale artifacts 105 to be interchangeably used with the scanner 101 depending on a size of the target object 110 to be scanned.

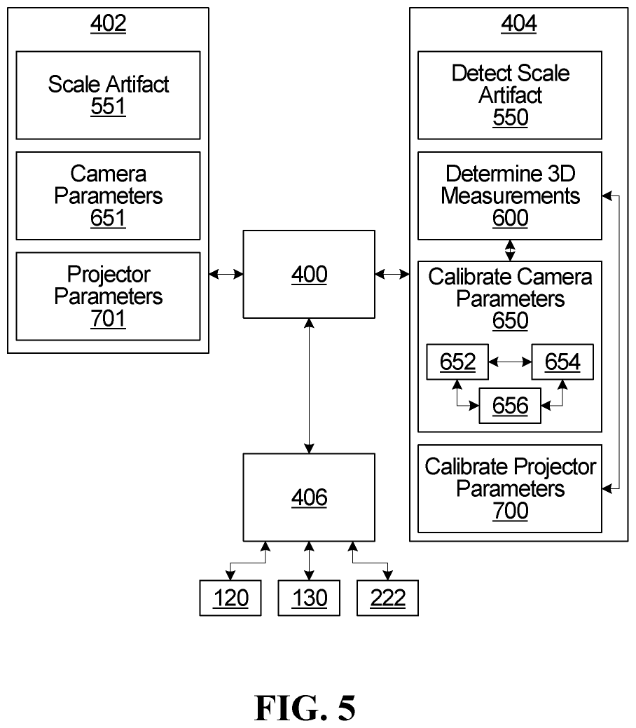

In the embodiment shown, the nominal scale element 302 comprises 2D code associated with the dimension information of the physical scale element 300. This 2D code may comprise a barcode or a QR code. The 2D code may encode the dimension information directly in the code, or may encode a storage location of the dimension information in a storage memory 402 (e.g., a uniform resource identifier identifying a storage location of the dimension information in a scale artifact data store 551 (shown in FIG. 5)). The nominal scale element 302 may be associated with the physical scale element 300 by being adjacent to, proximate to, or on the physical scale element 300. Representations of the nominal scale element 302 may also be included in certain images captured by the first and second cameras 120 and 130, and may be transmitted to the processor circuit 103. The processor circuit 103 may process the representation of the nominal scale element 302 in the images to identify the dimension information of the physical scale element 300, and/or to identify the storage location of the dimension information of the physical scale element 300 and retrieve the dimension information therefrom. The processor circuit 103 may also analyze images captured by the first and second cameras 120 and 130 to determine whether there is sufficient representation of the nominal scale element 302 in those frames to determine the dimension information or the storage location, and may further cause the user interface (not shown) associated with the scanning system 100 to provide an indication to the operator when the dimension information can be retrieved based on existing images and/or when more images including representations of the nominal scale element 302 are required.

In some embodiments, the nominal scale element 302 may instead comprise a numerical representation of the particular dimension information of the physical scale element 300 (e.g., such as “300 mm”, “302 mm”, “500 mm” and “1000 mm” for example, but may range between anywhere between approximately 200 mm and 10,000 mm). The numerical representation may be associated with the physical scale element 300 by being directly on the physical scale element 300. The numerical representation may also be included in certain frames captured by the first and second cameras 120 and 130 and may be transmitted to the processor circuit 103. The processor circuit 103 may process the numerical representation to determine the dimension information of the physical scale element 300.

In yet other embodiments, the scale artifact 105 may not include the nominal scale element 302 and may only include the physical scale element 300. In such embodiments, the operator may enter particular dimension information of the physical scale element 300 manually using the user interface (not shown) associated with the scanning system 100. The dimension information may be marked on the physical scale element 300 itself, such as on a back surface of the physical scale element 300. Alternatively or additionally, the dimension information of the physical scale element 300 may instead be hard-coded into the calibration procedures performed by the processor circuit 103.

### Processor Circuit 103

Referring now to FIGS. 1 and 5, the processor circuit 103 is generally configured to analyze and process the images captured by the first and second cameras 120 and 130, determine 3D measurements corresponding to features of the surface 112 of the target object 110 based on the images, and generate a 3D representation of the target object 110 based on the 3D measurements. In the embodiment shown, the processor circuit 103 is a separate device coupled to the scanner 101, such as a separate computer or other device for example; however, in other embodiments, the processor circuit 103 may be embedded in the housing 106 of the scanner 101. In the embodiment shown, the processor circuit 103 includes at least one processor 400, and a storage memory 402, program memory 404, and an input/output (I/O) interface 406 all in communication with the processor 400. Other embodiments of the processor circuit 103 may include fewer, additional or alternative components. Additionally, although only a single processor 400, single storage memory 402, single program memory 404 and a single I/O interface 406 is shown in FIG. 5, other embodiments of the processor circuit 103 may include more than one of each of these components. For example, the processor circuit 103 may include at least one first processor in the housing 106 of the scanner 101 configured to perform some of the functions of the processor circuit 103 and at least one second processor separate from the scanner 101 configured to perform some other of the functions of the processor circuit 103.

The I/O interface 406 includes an interface for the processor 400 to communicate commands to, and receive information from, other components of the scanner 101, such as with the first camera 120, the second camera 130 and the projector 222 for example. In the embodiment shown, the processor 400 may communicate with the first camera 120, the second camera 130 and the projector 222 via the wire connection; in other examples, the processor 400 may also communicate with one or more of the first camera 120, the second camera 130 in the projector 222 over the wireless network (not shown). The I/O interface 406 may include any communication interface which enables the processor 400 to communicate with the external components described above, including specialized or standard I/O interface technologies such as channel, port-mapped, asynchronous for example.

The storage memory 402 stores information received or generated by the processor 400, and may generally function as an information or data store. In the embodiment shown, the storage memory 402 includes the scale artifact data store 551, a camera parameters data store 651 and a projector parameters datastore 701; in other embodiments, the storage memory 402 may include fewer, additional or alternative data stores. The program memory 404 stores various blocks of code (alternatively called processor executable instructions and/or computer executable instructions), for directing the processor 400 to perform various processes, such as a detect scale artifact process 550, a determine 3D measurements process 600, a calibrate camera parameters procedure 650, and a calibrate projector parameters procedure 700 described below. The program memory 404 may also store database management system codes for managing the data stores in the storage memory 402. In other embodiments, the program memory 404 may store fewer, additional or alternative codes for directing the processor 400 to execute additional or alternative processes. The storage memory 402 and the program memory 404 may each be implemented as one or a combination of a non-transitory computer-readable medium and/or non-transitory machine-readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching thereof). The expression “non-transitory computer-readable medium” or “non-transitory machine-readable medium” as used herein is defined to include any type of computer-readable storage device and/or storage disk and to exclude propagating signals and to exclude transmission media.

The processor 400 is generally configured to execute instructions stored in the program memory 404 (including the detect scale artifact process 550, the determine 3D measurements process 600, the calibrate camera parameters procedure 650, and the calibrate projector parameters procedure 700 described below), to retrieve information from, and store information into, the data stores (including the scale artifact data store 551, the camera parameters data store 651 and the projector parameters datastore 701) of the storage memory 402, and to receive information from, and transmit commands to, the first camera 120, the second camera 130 and/or the projector 222 over the I/O interface 406.

### Operation of Scanning System 100

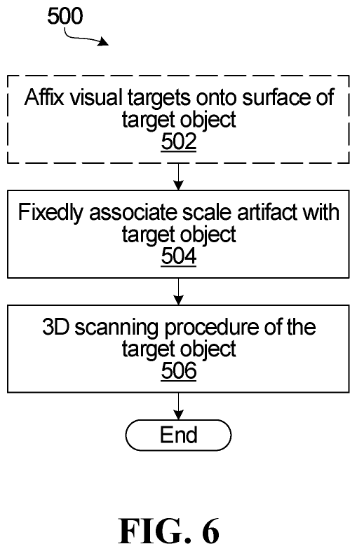

Referring to FIG. 6, a 3D measurement procedure 500 may begin at optional block 502, whereby an operator of the scanner 101 or another personnel may affix at least one visual target 501 to the surface 112 of the target object 110. The visual targets 501 may comprise circular stickers having a retroreflective surface and an adhesive surface opposite the retroreflective surface for adhesion to the surface 112. The visual targets 501 may improve feature extraction and matching as between different spatially neighboring images and/or different spatially neighboring frames and may generally improve accuracy of the 3D measurements generated by the processor circuit 103. For example, the visual targets 501 may allow relative positioning of different frames captured by the first and second cameras 120 and 130, and may also allow mapping of the different frames to a pre-generated model of the target object 110. However, some embodiments of the 3D measurement procedure 500 may not include optional block 502 and the visual targets 501 may be omitted.

The 3D measurement procedure 500 then continues to block 504, whereby the operator of the scanner 101 or another personnel may fixedly associate the scale artifact 105 with the target object 110. As described above, the scale artifact 105 may be fixedly associated with the target object 110 by being affixed to the surface 112, or by being positioned at the fixed scale position adjacent to, in front of, or proximate to a fixed object position of the target object 110. In embodiments where the scale artifact 105 includes both the physical scale element 300 and the nominal scale element 302, the physical scale element 300 may be first fixedly associated with the target object, and the nominal scale element 302 may then be associated with the physical scale element 300. As described above, the nominal scale element 302 may be associated with the physical scale element 300 by being affixed the surface 112 adjacent or otherwise proximate to the physical scale element 300 or by being affixed directly to the physical scale element 300 itself. In embodiments where the scale artifact 105 only includes the physical scale element 300, the operator or another personnel may instead enter the dimension information associated with the scale artifact 105 directly to the processor circuit 103 using the user interface (not shown) of with the scanning system 100.

The 3D measurement procedure 500 then continues to block 506, whereby the operator of the scanner 101 may control the scanner 101 to initiate and conduct a 3D scanning procedure of the target object 110 with the scale artifact 105 fixedly associated therewith. For example, the operator may actuate a physical input button associated with the scanner 101 or a software-based button provided by the user interface (not shown) of the scanning system 100 to initiate the 3D scanning procedure. In response to the operator initiating the 3D scanning procedure, the processor circuit 103 may transmit commands to the first camera 120 and the second camera 130 to capture a plurality of first and second spatially neighboring images and a plurality of frames of the surface 112 of the target object 110 over a plurality of different time points t₁, t₂, [. . .] tₙ, [. . .], t_{end}, whereby the 3D scanning procedure starts at the first time point t₁ and ends at the end time point t_{end}. In response to the operator initiating the 3D scanning procedure, the processor circuit 103 may also transmit commands to cause the projector 222 to project the plurality of light planes 230 in a light pattern (e.g., the pattern 234) onto the surface 112.

To conduct the 3D scanning procedure (i.e., during block 506), a relative position and pose of the scanner 101 relative to a particular feature (or point) on the surface 112 of the target object 110 may be changed over the plurality of different time points. For example, the scanner 101 may be moved relative to a static target object 110; moving the scanner 101 may change a position of the first camera origin 121, the second camera origin 131 and the projector origin 231 within the world reference frame 118. Alternatively, in embodiments where the target object 110 is positioned on a turntable and may be rotated, the target object 110 may be rotated relative to a static scanner 101; moving the target object 110 may change a position of a particular feature on the surface 112 within the world reference frame 118. Further still, both the scanner 101 and the target object 110 may be moved relative to each other in some embodiments. The relative movement generally enables the scanner 101 to capture frames including representations of different portions of the surface 112 to enable the scanner 101 generate 3D measurements for features on the entire surface 112 and eventually generate the 3D representation of the target object 110.

### Detect Scale Artifact Process 550

While the 3D scanning procedure is being conducted (i.e., during block 506), the processor 400 may initiate the detect scale artifact process 550 based on images which have been captured by the first and second cameras 120 and 130 up to a current time point (e.g., tₙ). The phrase “while the 3D scanning procedure is being conducted” or “during the 3D scanning procedure” as used herein generally means performing a particular process (e.g., the detect scale artifact process 550, the calibrate camera parameters procedure 650 and the calibrate projector parameters procedure 700) while the first and second camera 120 and 130 are still capturing images and while the projector 222 is still projecting the light pattern onto the surface 112. In the embodiment shown, the detect scale artifact process 550 is performed by the processor 400 executing processor-readable instructions and/or computer-readable instructions stored in the program memory 404; in other embodiments, the detect scale artifact process 550 may comprise processor-readable instructions and/or computer-readable instructions alternatively stored on other non-transitory computer readable storage medium; in yet other embodiments, the detect scale artifact process 550 and/or parts thereof may alternatively be executed by a device other than the processor 400.

The detect scale artifact process 550 may include codes directing the processor 400 to determine whether the images captured up to the current tₙ include a sufficient representation of the physical scale element 300 of the scale artifact 105. For example, keypoints associated with the different physical scale features of the physical scale element 300 may be previously identified and stored in the storage memory 402 (e.g., within the scale artifact data store 551). The detect scale artifact process 550 may direct the processor 400 to attempt to identify these keypoints in the captured images and determine whether a sufficient number of keypoints can be identified in the captured images. For example, the detect scale artifact process 550 may direct the processor 400 to determine whether a keypoint associated with the first physical scale feature Pₐ and a keypoint associated with the second physical scale feature P_{b} of the physical scale element 300 can be identified in the captured images. If these two key points can be identified, the detect scale artifact process 550 may determine that there is sufficient representation of the physical scale element 300. In other embodiments, detect scale artifact process 550 may require the processor 400 to identify keypoints associated with at least one further set of the physical scale features of the physical scale element 300 before determining that there is sufficient representation.

Additionally or alternatively, the detect scale artifact process 550 may direct the processor 400 to determine whether the images captured up to the current tₙ include multiple convergent observations of the first end 305 of the physical scale element 300 and/or multiple convergent observations of the second end 306 of the physical scale element 300. These multiple convergent observations may be based on corresponding virtual hemispheres centered on, respectively, the first end 305 and the second end 306. In some embodiments, each virtual hemisphere may be separated into 10 generally equal and generally pentagonal sections. In other embodiments, each virtual hemisphere may be separated into three, five, six, eight, nine, 15, 20 or 100 equal sections. In yet other embodiments, each virtual hemisphere may be separated into unequal sections. In yet other embodiments, the sections may have a triangular shape, a square shape, a hexagonal shape or another a polygonal shape. The detect scale artifact process 550 may determine that there is sufficient representation of the physical scale element 300 when there is an observation of the first end 305 and/or of the second end 306 from each section of the virtual hemisphere correspondingly associated with that end 305 and 306. Further, the detect scale artifact process 550 may direct the processor 400 to cause a display (not shown) associated with the processor circuit 103 and/or the scanner 101 to display an indication to the operator when the captured images do not include sufficient representation of the physical scale element 300, and may prompt the operator to capture more images including the physical scale element 300.

In embodiments where the scale artifact 105 also includes the nominal scale element 302, the detect scale artifact process 550 may further include codes directing the processor 400 to determine whether the images captured up to the current tₙ include a sufficient representation of the nominal scale element 302 to retrieve the dimension information of the physical scale element 300 therefrom. For example, in embodiments where the nominal scale element 302 comprises a 2D code such as a QR code or a barcode, the detect scale artifact process 550 may direct the processor 400 to determine whether there is a sufficiently good representation of the QR code or the barcode in the captured images to extract the dimension information encoded therein, or to extract the storage location of the dimension information encoded therein. Methods for encoding data within, and extracting data from, extraction from QR codes and barcodes are known to those skilled in the art and are not further described here. Further, the detect scale artifact process 550 may direct the processor 400 to cause the display (not shown) to display an indication to the operator when the captured frames do not include a sufficient representation of the nominal scale element 302, and may prompt the operator to capture more frames including the nominal scale element 302.

In some embodiments, when the processor 400 detects a portion of the nominal scale element 302 in the images captured up to up to the current tₙ, the detect scale artifact process 550 may also direct the processor 400 transmit a command to the projector 222 to stop projecting the plurality of light planes 230 which resolves as the light pattern 234 onto the surface 112 for a period of time. This period of time may be approximately 1 ms, 10 ms, 16 ms, 100 ms, 500 ms, 1 s, or 2 s for example. The period of time may correspond to an amount of time it takes for the first and second cameras 120 and 130 to capture a single frame. Accordingly, at least some frames captured by the first and second cameras 120 and 130 which include a representation of the nominal scale element 302 may not include a representation of the light pattern 234. This can allow the dimension information and/or the storage location to be more easily extracted from the nominal scale element 302.

The detect scale artifact process 550 may be performed more than one time during a particular 3D scanning procedure (i.e., during block 506). For example, the detect scale artifact process 550 may be continuously executed by the processor 400 in the background (i.e., may analyze every frame captured by the first and second cameras 120 and 130). Additionally or alternatively, the detect scale artifact process 550 may be executed by the processor 400 at intervals, such as after a particular amount of time has passed and/or after a particular number of frames have been captured by the first and second cameras 120 and 130.

### Determine 3D Measurements Process 600

After the 3D scanning procedure is conducted (i.e., after block 506), the processor 400 may initiate the determine 3D measurements process 600 based on all images which have been captured by the first and second cameras 120 and 130 up to the t_{end} of the 3D scanning procedure. The phrase “after the 3D scanning procedure is conducted” or “after the 3D scanning procedure” as used herein generally means performing a particular process (e.g., the determine 3D measurements process 600, the calibrate camera parameters procedure 650, or the calibrate projector parameters procedure 700), or a portion thereof, after the first and second camera 120 and 130 have finished capturing images of the surface 112. In the embodiment shown, the determine 3D measurements process 600 is performed by the processor 400 executing processor-readable instructions and/or computer-readable instructions stored in the program memory 404; in other embodiments, the determine 3D measurements process 600 may comprise processor-readable instructions and/or computer-readable instructions alternatively stored on other non-transitory computer readable storage medium; in yet other embodiments, the determine 3D measurements process 600 and/or parts thereof may alternatively be executed by a device other than the processor 400.

The determine 3D measurements process 600 may include codes directing the processor 400 to analyze the plurality of spatially neighboring frames captured by the first and second cameras 120 and 130 over the plurality of different time points (e.g., t₁, t₂, [. . .] tₙ, [. . .], t_{end}) and over a plurality of different poses of the scanner 101 relative to the target object 110 to (a) extract features from frames captured by the first and second cameras 120 and 130, (b) match features as between different pairs of spatially neighboring frames, and (c) determine initial 3D measurements of the extracted and matched features in the world reference frame 118

$$[ \begin{matrix}{\hat{x}}_{w} \\ {\hat{y}}_{w} \\ {\hat{z}}_{w}\end{matrix} ] .$$

To extract and match features, the determine 3D measurements process 600 may include codes directing the processor 400 to extract features in the images associated with at least one of representations of the light lines 232 formed on the surface 112 by the light planes 230 projected by the projector 222, representations of at least some of the visual targets 501 affixed onto the surface 112, or representations of the scale artifact 105 fixedly associated with the target object 110. Feature extraction and matching may be performed using a variety of different feature descriptors known to those skilled in the art and are not described in detail herein.

To determine 3D measurements of the extracted and matched features, the determine 3D measurements process 600 may include codes directing the processor 400 to perform triangulation calculations known to those skilled in the art. To assist in understanding the present disclosure, some concepts relevant to a camera model for converting 2D pixel coordinates in a frame captured by the first camera 120 or the second camera 130 into 3D measurements (also referred to as 3D coordinates) in the world reference frame 118

$$[ \begin{matrix}{\hat{x}}_{w} \\ {\hat{y}}_{w} \\ {\hat{z}}_{w}\end{matrix} ]$$

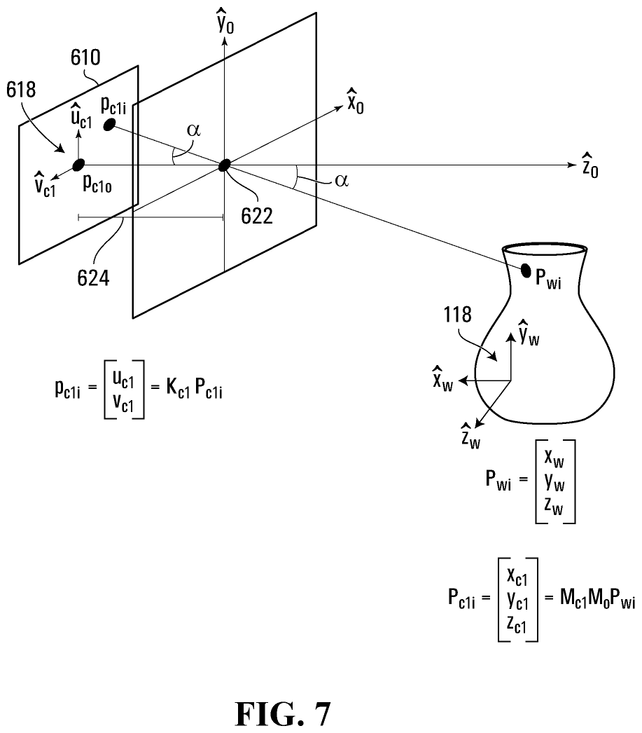

are first discussed with reference to FIGS. 7, 8 and 9. The camera model is explained with reference to the first camera 120; however, those skilled in the art will appreciate that the below description would also be similarly applicable the second camera 130 or any other camera of the scanner 101.

Referring to FIG. 7, a particular 3D feature

$${P}_{wi} = [ \begin{matrix}{x}_{w} \\ {y}_{w} \\ {z}_{w}\end{matrix} ]$$

on the surface 112 in the world reference frame 118 may be captured as a 2D feature

$${p}_{c 1 i} = [ \begin{matrix}{u}_{c 1} \\ {v}_{c 1}\end{matrix} ]$$

in a 2D image reference frame 618

$$[ \begin{matrix}{\hat{u}}_{c 1} \\ {\hat{v}}_{c 1}\end{matrix} ]$$

of an image 610 captured by the first camera 120. In some embodiments, converting the 2D feature P_{c1i} in the image reference frame 618 into the 3D feature P_{wi} in the world reference frame 118 is a two-step process involving (1) converting the 2D coordinates in the image reference frame 618 into 3D measurements (i.e., a point along a 3D vector emanating from a pinhole 622 of the first camera 120) in the sensor reference frame 128

$$[ \begin{matrix}{\hat{x}}_{o} \\ {\hat{y}}_{o} \\ {\hat{z}}_{o}\end{matrix} ]$$

utilizing intrinsic parameters of the first camera 120 and lens distortion associated with the first camera 120 and (2) converting the 3D measurements (i.e., the point along the 3D vector emanating from the pinhole 622) in the sensor reference frame 128 into 3D measurements in the world reference frame 118 utilizing extrinsic parameters of the first camera 120.

Intrinsic parameters K of a camera describe how the camera internally converts a 3D scene into a 2D frame. Referring to FIG. 7, intrinsic parameters K_{c1} of the first camera 120 may be expressed as an intrinsic matrix represented in equation (3), which accounts for focal length, principal point, and axis skew of the first camera 120. The intrinsic parameters K_{c2} of the second camera 130 may be expressed as a similar intrinsic matrix represented in equation (3a)

$${K}_{c 1} = [ \begin{matrix}{s}_{c 1} {f}_{c 1} / p & {γ}_{c 1} & {u}_{c 1 o} & 0 \\ 0 & {f}_{c 1} / p & {v}_{c 1 o} & 0 \\ 0 & 0 & 1 & 0\end{matrix} ] \qquad ( 3 )$$

whereby f_{c1} is a distance 624 between the pinhole 622 of the first camera 120 and an image plane of the image 610 (i.e., focal length); s_{c1} is a scale factor of f_{c1}, which allows for rectangular pixels (rather than square pixels); p is pixel size; u_{c1o}, v_{c1o} is the 2D coordinates of a principal point p_{c1o} of the image 610 (may be represented in pixels); and γ_{c1} is an axis skew of the pinhole 622 of the first camera 120.

$${K}_{c 2} = [ \begin{matrix}{s}_{c 2} {f}_{c 2} / p & {γ}_{c 2} & {u}_{c 2 o} & 0 \\ 0 & {f}_{c 2} / p & {v}_{c 2 o} & 0 \\ 0 & 0 & 1 & 0\end{matrix} ] \qquad ( 3 a )$$

In the embodiment shown, the intrinsic parameters K_{c1} of the first camera 120, and in particular f_{c1}, can be used to transform a 3D coordinate

$${P}_{c 1 i} = [ \begin{matrix}{x}_{c 1} \\ {y}_{c 1} \\ {z}_{c 1}\end{matrix} ] = [ \begin{matrix}{x}_{o} \\ {y}_{o} \\ {z}_{o}\end{matrix} ]$$

in the first camera reference frame/sensor reference frame 128 into the 2D feature p_{c1i} in the image reference frame 618 as shown in equation (4) and generally based on principles of similar triangles (that angle α in the ŷₒ\hat{z}ₒ plane and the ŷₒ\hat{z}ₒ plane would be same as, respectively, α′ along \hat{v}_{c1} and û_{c1}) as known to those skilled in the art. Similarly, intrinsic parameters K_{c2} of the second camera 130 can be used to transform a 3D feature

$${P}_{c 2 i} = [ \begin{matrix}{x}_{c 2} \\ {y}_{c 2} \\ {z}_{c 2}\end{matrix} ]$$

in the second camera reference frame 138

$$[ \begin{matrix}{\hat{x}}_{c 2} \\ {\hat{y}}_{c 2} \\ {\hat{z}}_{c 2}\end{matrix} ]$$

into a 2D feature

$${P}_{c 2 i} = [ \begin{matrix}{u}_{c 2} \\ {v}_{c 2}\end{matrix} ]$$

in a 2D image reference frame

$$[ \begin{matrix}{\hat{u}}_{c 2} \\ {\hat{v}}_{c 2}\end{matrix} ]$$

of an image capturd by the second camera 130 as shown in equation (5).

$${P}_{c 1 i} = [ \begin{matrix}{u}_{c 1} \\ {v}_{c 1}\end{matrix} ] = π ( {K}_{c 1} {P}_{c 1 iH} ) = π ( [ \begin{matrix}{s}_{c 1} {f}_{c 1} / p & {γ}_{c 1} & {u}_{c 1 o} & 0 \\ 0 & {f}_{c 1} / p & {v}_{c 1 o} & 0 \\ 0 & 0 & 1 & 0\end{matrix} ] [ \begin{matrix}{x}_{o} \\ {y}_{o} \\ {z}_{o} \\ 1\end{matrix} ] ) \qquad ( 4 )$$

$${P}_{c 2 i} = [ \begin{matrix}{u}_{c 2} \\ {v}_{c 2}\end{matrix} ] = π ( {K}_{c 2} {P}_{c 2 iH} ) = π ( [ \begin{matrix}{s}_{c 2} {f}_{c 2} / p & {γ}_{c 2} & {u}_{c 2 o} & 0 \\ 0 & {f}_{c 2} / p & {v}_{c 2 o} & 0 \\ 0 & 0 & 1 & 0\end{matrix} ] [ \begin{matrix}{x}_{c 2} \\ {y}_{c 2} \\ {z}_{c 2} \\ 1\end{matrix} ] ) \qquad ( 5 )$$

whereby subscript H represents a conversion to homogeneous coordinates from

$$P ( x , y , z ) = [ \begin{matrix}x \\ y \\ z\end{matrix} ] to {P ( x , y , z )}_{H} = [ \begin{matrix}x \\ y \\ z \\ 1\end{matrix} ] ;$$

and π represents a dehomogenization function such that

$$π ( {P ( x , y , z )}_{H} ) = π ( [ \begin{matrix}x \\ y \\ z\end{matrix} ] ) = [ \begin{matrix}x / z \\ y / z\end{matrix} ] .$$

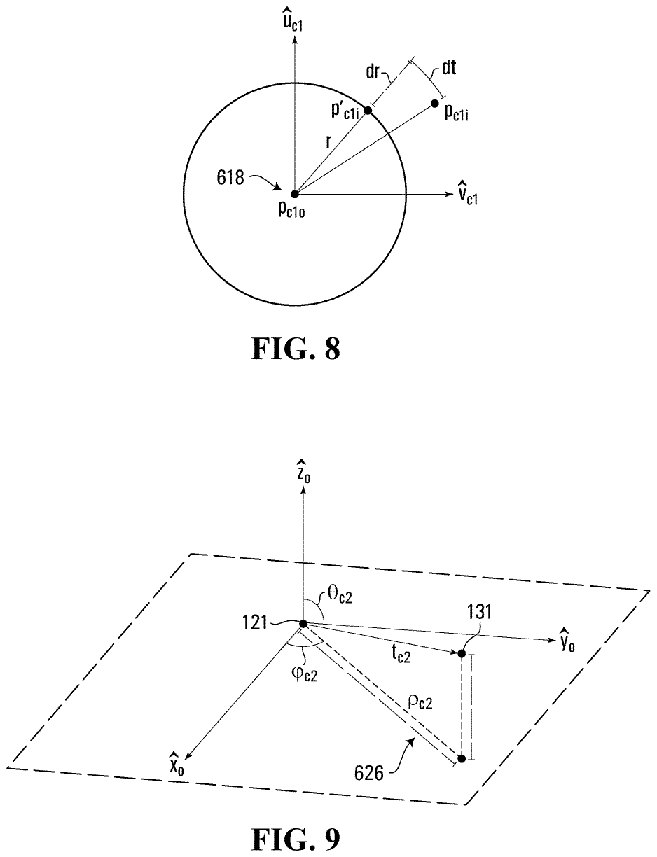

Lens distortion D describe how a lens of a camera may distort the 3D scene in the 2D frame and generally accounts for how a pinhole (e.g., the pinhole 622 of the first camera 120) of the camera in the camera model is a physical lens which may receive rays from the 3D scene at different points on a plane rather than a single point represented by the pinhole. Referring to FIG. 8, there are two main types of lens distortion: (1) radial distortion dr which occurs due to light rays bending more at edges of the lens than an optical centre of the lens and (2) tangential distortion dt which occurs when the lens is not parallel to a plane of an image captured by the camera (e.g., the image 610 captured by the first camera 120). Referring to FIG. 8, the 2D feature p_{c1i} in the image 610 captured by the first camera 120 may be corrected for radial distortion with two or more radial distortion coefficients k₁, k₂ (e.g., calculated as an offset dr along a radius r extending from the principal point p_{c1o}) and for tangential distortion with two or more tangential distortion coefficients T₁, T₂ (calculated as an offset dt perpendicular to the radius r). The radial and tangential coefficients k₁,k₂,T₁,T₂ may be calculated based on circumferential geometry and in different manners as known to those skilled in the art.

In the embodiment shown, lens distortion D_{c1} of the first camera 120 can be used to transform the 2D feature p_{c1i} in the 2D image reference frame 618 into an undistorted 2D feature

$${p}_{c 1 i}^{′} = [ \begin{matrix}{u}_{c 1}^{′} \\ {v}_{c 1}^{′}\end{matrix} ]$$

in the same 2D image reference frame 618 as shown in equation (6). Similarly, the lens distortion D_{c2} of the second camera 130 can be used to transform the 2D feature p_{c2i} in the 2D image reference frame of an image captured by the second camera 130 into an undistorted 2D feature

$${p}_{c 2 i}^{′} = [ \begin{matrix}{u}_{c 2}^{′} \\ {v}_{c 2}^{′}\end{matrix} ]$$

in the same 2D image reference frame as shown in equation (7).

$${p}_{c 1 i}^{′} = [ \begin{matrix}{u}_{c 1}^{′} \\ {v}_{c 1}^{′}\end{matrix} ] = d ( {p}_{c 1 i} , {D}_{c 1} ) = d ( [ \begin{matrix}{u}_{c 1} \\ {v}_{c 1}\end{matrix} ] , {k}_{c 11} , {k}_{c 12} , {T}_{c 11} , {T}_{c 12} ) \qquad ( 6 )$$

$${p}_{c 2 i}^{′} = [ \begin{matrix}{u}_{c 2}^{′} \\ {v}_{c 2}^{′}\end{matrix} ] = d ( {p}_{c 2 i} , {D}_{c 2} ) = d ( [ \begin{matrix}{u}_{c 2} \\ {v}_{c 2}\end{matrix} ] , {k}_{c 21} , {k}_{c 22} , {T}_{c 21} , {T}_{c 22} ) \qquad ( 7 )$$

Extrinsic parameters M of a camera describe how the camera is currently positioned in the world reference frame 118

$$[ \begin{matrix}{\hat{x}}_{w} \\ {\hat{y}}_{w} \\ {\hat{z}}_{w}\end{matrix} ] .$$

Referring back to FIG. 7, and as described above, extrinsic parameters Mₒ of the origin point of the scanner 101 (e.g., the first camera origin 121 of the first camera 120) may be expressed as an extrinsic matrix including the rotation matrix Rₒ representing a rotation of the sensor reference frame 128

$$[ \begin{matrix}{\hat{x}}_{o} \\ {\hat{y}}_{o} \\ {\hat{z}}_{o}\end{matrix} ]$$

relative to the world reference frame 118 as shown in equation (8) and a translation vector tₒ representing a translation of the origin point (e.g., the first camera origin 121) of the sensor reference frame 128 relative to an origin of the world reference frame 118.

$${R}_{o} = [ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ] \qquad ( 8 )$$

whereby the first row describes rotation of \hat{x}ₒ of the sensor reference frame 128 relative to \hat{x}_{w} of the world reference frame 118; the second row describes the rotation of ŷₒ of the sensor reference frame 128 relative to ŷ_{w} of the world reference frame 118; and the third row describes the rotation of \hat{z}ₒ of the sensor reference frame 128 relative to the \hat{z}_{w} of the world reference frame 118.

For some bundle adjustment and calibration procedures, the first camera 120 may need to be orientated in the sensor reference frame 128

$$[ \begin{matrix}{\hat{x}}_{o} \\ {\hat{y}}_{o} \\ {\hat{z}}_{o}\end{matrix} ]$$

to fix a common origin. In this regard, the extrinsic parameters Mₒ of the origin point of the scanner 101 may be used in combination with the stereo extrinsic parameters M_{c1} of the first camera 120 (describing a pose of the first camera 120 relative to the sensor reference frame 128, and including the rotation matrix R_{c1} and the translation vector t_{c1} of the first camera origin 121 of the first camera 120 relative to the origin point of the scanner 101) to transform the 3D feature P_{wi} in the world reference frame 118

$$[ \begin{matrix}{\hat{x}}_{w} \\ {\hat{y}}_{w} \\ {\hat{z}}_{w}\end{matrix} ]$$

into 3D feature Pₒᵢ in the sensor reference frame 128

$$[ \begin{matrix}{\hat{x}}_{o} \\ {\hat{y}}_{o} \\ {\hat{z}}_{o}\end{matrix} ]$$

as shown in equation (9) and then into a 3D feature P_{c1i} in the first camera reference frame

$$[ \begin{matrix}{\hat{x}}_{c 1} \\ {\hat{y}}_{c 1} \\ {\hat{z}}_{c 1}\end{matrix} ]$$

as then shown in equation (9a). In embodiments where the first camera origin 121 comprises the origin point of the scanner 101, the first camera reference frame

$$[ \begin{matrix}{\hat{x}}_{c 1} \\ {\hat{y}}_{c 1} \\ {\hat{z}}_{c 1}\end{matrix} ]$$

is the same as the sensor reference frame 128 and the stereo extrinsic parameters M_{c1} of the first camera 120 may be a 4×4 identity matrix (e.g., a square matrix which contains on a value of 1 on the diagonal elements and a value of 0 on the remaining matrix elements), such that Mₒ remains unchanged when transformed by M_{c1} as shown in equation (9b).

$${P}_{oiH} = [ \begin{matrix}{P}_{oix} \\ {P}_{oiy} \\ {P}_{oiz} \\ 1\end{matrix} ] = [ \begin{matrix}{x}_{o} \\ {y}_{o} \\ {z}_{o} \\ 1\end{matrix} ] = {M}_{o} {P}_{wiH} = [ \begin{matrix}{r}_{11} & {r}_{12} & {r}_{13} & {t}_{o x} \\ {r}_{21} & {r}_{22} & {r}_{23} & {t}_{o y} \\ {r}_{31} & {r}_{32} & {r}_{33} & {t}_{o z} \\ 0 & 0 & 0 & 1\end{matrix} ] [ \begin{matrix}{x}_{w} \\ {y}_{w} \\ {z}_{w} \\ 1\end{matrix} ] \qquad ( 9 )$$

$${P}_{c 1 iw} = [ \begin{matrix}{P}_{c 1 ix} \\ {P}_{c 1 iy} \\ {P}_{c 1 iz} \\ 1\end{matrix} ] = [ \begin{matrix}{x}_{c 1} \\ {y}_{c 1} \\ {z}_{c 1} \\ 1\end{matrix} ] = {M}_{c 1} {M}_{o} {P}_{wiH} = [ \begin{matrix}{r}_{11} & {r}_{12} & {r}_{13} & {t}_{c 1 x} \\ {r}_{21} & {r}_{22} & {r}_{23} & {t}_{c 1 y} \\ {r}_{31} & {r}_{32} & {r}_{33} & {t}_{c 1 z} \\ 0 & 0 & 0 & 1\end{matrix} ] [ \begin{matrix}{x}_{w} \\ {y}_{w} \\ {z}_{w} \\ 1\end{matrix} ] \qquad ( 9 a )$$

$${P}_{c 1 iw} = {P}_{oiH} = {M}_{o} {P}_{wiH} \qquad ( 9 b )$$

Similarly, for certain bundle adjustment and calibration procedures as described below, the second camera 130 may also need to be orientated in the sensor reference frame 128 to fix a common origin. The stereo extrinsic parameter M_{c2} of the second camera 130 (describing a pose of the second camera 130 relative to the sensor reference frame 128, and including the rotation matrix R_{c2} and the translation vector t_{c2} of the second camera origin 131 of the second camera 130 relative to the origin point of the scanner (e.g., the first camera origin 121) as described above) may also be used in combination with the extrinsic parameters Mₒ of the origin point of the scanner 101 (e.g., the first camera origin 121) to transform the 3D feature P_{wi} in the world reference frame 118 into a 3D feature Pₒᵢ in the sensor reference frame 128 as shown in equation (9) above, and then to transform into the 3D feature P_{c2i} in the second camera reference frame 138 as shown in equation (10).

$${P}_{c 2 iH} = [ \begin{matrix}{P}_{c 2 ix} \\ {P}_{c 2 iy} \\ {P}_{c 2 iz} \\ 1\end{matrix} ] = [ \begin{matrix}{x}_{c 2} \\ {y}_{c 2} \\ {z}_{c 2} \\ 1\end{matrix} ] = {M}_{c 2} {M}_{o} {P}_{wiH} = [ \begin{matrix}{r}_{11} & {r}_{12} & {r}_{13} & {t}_{c 2 x} \\ {r}_{21} & {r}_{22} & {r}_{23} & {t}_{c 2 y} \\ {r}_{31} & {r}_{32} & {r}_{33} & {t}_{c 2 z} \\ 0 & 0 & 0 & 1\end{matrix} ] [ \begin{matrix}{x}_{w} \\ {y}_{w} \\ {z}_{w} \\ 1\end{matrix} ] \qquad ( 10 )$$

Based on the equation (10) above, the the extrinsic parameters Mₒ of the origin point (e.g., the first camera origin 121) may be used to transform a 3D feature

$${P}_{c 2 i} = [ \begin{matrix}{x}_{c 2} \\ {y}_{c 2} \\ {z}_{c 2}\end{matrix} ]$$

in the second camera reference frame 138 into a corresponding 3D feature

$${P}_{c 2 i}^{′} = [ \begin{matrix}{x}_{o} \\ {y}_{o} \\ {z}_{o}\end{matrix} ]$$

in the sensor reference frame 128 as shown in equation (11). Additionally, the translation vector t_{c2} of the stereo extrinsic parameters M_{c2} of the second camera 130 can be expanded out and defined using angles relative to the \hat{x}ₒ, the ŷ_{y} and the \hat{z}ₒ axis of the sensor reference frame 128 as shown in equation (11).

$${P}_{c 2 iH} = [ \begin{matrix}{x}_{c 2} \\ {y}_{c 2} \\ {z}_{c 2} \\ 1\end{matrix} ] = {M}_{c 2} {P}_{c 2 iH}^{′} [ \begin{matrix}{r}_{11} & {r}_{11} & {r}_{11} & {ρ}_{c 2} sin ( {θ}_{c 2} ) cos ( {φ}_{c 2} ) \\ {r}_{21} & {r}_{21} & {r}_{21} & {ρ}_{c 2} sin ( {θ}_{c 2} ) sin ( {φ}_{c 2} ) \\ {r}_{31} & {r}_{31} & {r}_{31} & {ρ}_{c 2} cos ( {θ}_{c 2} ) \\ 0 & 0 & 0 & 1\end{matrix} ] [ \begin{matrix}{x}_{o} \\ {y}_{o} \\ {z}_{o} \\ 1\end{matrix} ] \qquad ( 11 )$$

whereby, referring to FIG. 9, ρ_{c2} is a length of a remapped separation distance 626 of the translation vector t_{c1} between the camera origins 121 and 131 onto the \hat{x}ₒŷ plane of the sensor reference frame 128; φ_{c2} is an angle of the remapped separation distance 626 relative to \hat{x}ₒ; and θ_{c2} is an angle of the translation vector c2 relative to \hat{z}ₒ.

As described below, as the first and second cameras 120 and 130 are generally located on the same baseline of the scanner 101, ρ_{c2} and the remapped separation distance 626 may represent and/or be a function of the camera separation distance 135 between the first and second cameras 120 and 130 (shown in FIGS. 2, 3A and 3B), or more generally between the second camera 130 and any origin point of the scanner 101. In embodiments where the first camera 120 is not the origin sensor, an expansion similar to equation (11) may be performed for P_{c1i} and t_{c1}. Similarly, in embodiments where the set of cameras 102 includes additional cameras other than the first and second cameras 120 and 130 (e.g., c3, c4 [. . .] cn), equations and expansions similar to equations (9), (10) and (11) may be performed to determine a 3D feature Pₓᵢ in camera reference frames of the additional cameras and to expand out similar Pₓᵢ and tₓ (whereby x ϵ {c1, c₂, c₃ . . . cn}).

### Measurement Bundle Adjustment

The determine 3D measurements process 600 may also include codes directing the processor 400 to perform a measurement bundle adjustment procedure on all initial 3D measurements of the surface 112 initially determined by the processor 400. An embodiment of the measurement bundle adjustment procedure is shown in equation (13), which aims to minimize error with respect to the 3D measurements P_{wi} of the surface 112 of the target object 110, and the extrinsic parameters Mₒ of the origin point of the scanner 101 (e.g., rotation Rₒ and translation tₒ of the sensor reference frame 128 relative to the world reference frame 118—in other words, an estimated pose of the origin point of the scanner 101 in the world reference frame 118) by equally distributing error in the 3D measurements P_{wi} of the surface 112, the extrinsic parameters Mₒ of the origin point, and the stereo extrinsic parameters Mₓ (e.g., M_{c1} or M_{c2}) of the first and second cameras 120 and 130 relative to the Mₒ of the origin point over an entire scene captured in images of the first and second cameras 120 and 130.

$${arg min}_{{M}_{o} , {P}_{wiH}} {\sum }_{i , x , o} ‖ d ( {p}_{x i} , {D}_{x} ) - π ( {K}_{x} {M}_{x} {M}_{o} {P}_{w i H} ) ‖ 2 \qquad ( 13 )$$

whereby x ϵ {c1, c2}, and in embodiments where the set of cameras 102 includes additional cameras c3, c4 [. . .], cn, x ϵ {c1, c2, c3 . . . cn}; pₓᵢ is a distorted 2D coordinate of a particular feature i in images captured by the first camera 120 in the image reference frame 618

$$[ \begin{matrix}{\hat{u}}_{c 1} \\ {\hat{v}}_{c 1}\end{matrix} ]$$

or in images captured by the second camera 130 in the image reference frame

$$[ \begin{matrix}{\hat{u}}_{c 2} \\ {\hat{v}}_{c 2}\end{matrix} ] ;$$

P_{wi} is the 3D measurements of the particular feature i in the 3D world reference frame 118

$$[ \begin{matrix}{\hat{x}}_{w} \\ {\hat{y}}_{w} \\ {\hat{z}}_{w}\end{matrix} ] ;$$

Dₓ is the lens distortion of either the first and second cameras 120 and 130 (or any additional cameras) as described above; Kₓ is the intrinsic parameters of either the first and second cameras 120 and 130 (or any additional cameras) as described above; Mₒ is the extrinsic parameters of the origin point as described above; Mₓ is the stereo extrinsic parameters of either the first and second cameras 120 and 130 (or any additional cameras) as described above; for x=c1, in embodiments where the first camera 120 forms the origin sensor and the first camera origin 121 forms the origin point (e.g., in embodiments where the first camera reference frame is equivalent to the sensor reference frame 128), M_{c1} is a 4×4 identity matrix.

In the measurement bundle adjustment of equation (13), the 3D measurements P_{wi} of the surface 112 and the extrinsic parameters Mₒ of the origin point of the scanner 101 (e.g., the pose of the first camera 120 in the world reference frame 118 as described above) are “unconstrained variables” being minimized and thus solved for, whereas the lens distortion Dₓ, the 2D coordinates pₓᵢ, the intrinsic parameters Kₓ and the stereo extrinsic parameters Mₓ are “fixed variables” which are known and which are used to solve the unconstrained variables. In some embodiments, the “fixed variables” may instead be “constrained variables” with an unknown value but constrained to a range. The values of the “fixed variables” of the lens distortion Dₓ, the 2D coordinates Pₓᵢ, the intrinsic parameters Kₓ and the stereo extrinsic parameters Mₓ may be retrieved from the camera parameters data store 651 of the storage memory 402, and may be values which are initially factory set at manufacture of the scanner 101 and/or values determined via a previous calibrate camera parameters procedure 650 (described below) and stored in the camera parameters data store 651 for example. The measurement bundle adjustment may be performed using a variety of different commercially available bundle adjustment software. Those skilled in the art will also appreciate that other optimization algorithms different from bundle adjustment may be used to optimize the initial 3D measurement of the surface 112 initially determined by the processor 400.

In the embodiment shown, the determine 3D measurements process 600 may perform the measurement bundle adjustment (e.g., the measurement bundle adjustment shown in equation (13)) after the 3D scanning procedure (i.e., after block 506 shown in FIG. 6). However, in other embodiments, the measurement bundle adjustment may be performed during the 3D scanning procedure (i.e., during block 506) using images captured, and initial 3D measurements determined, up to a current tₙ during the 3D scanning procedure. Additionally, the measurement bundle adjustment may be performed more than one time during a particular 3D scanning procedure. For example, the measurement bundle adjustment may be continuously executed by the processor 400 in the background (i.e., the processor 400 may analyze every image captured by the first and second cameras 120 and 130 to generate initial 3D measurements therefrom and perform the measurement bundle adjustment on such initial 3D measurements). As an additional example, the measurement bundle adjustment may be executed by the processor 400 at intervals, as after a particular amount of time has passed and/or after a particular number of images and/or frames have been captured by the first and second cameras 120 and

### Calibrate Camera Parameters Procedure 650

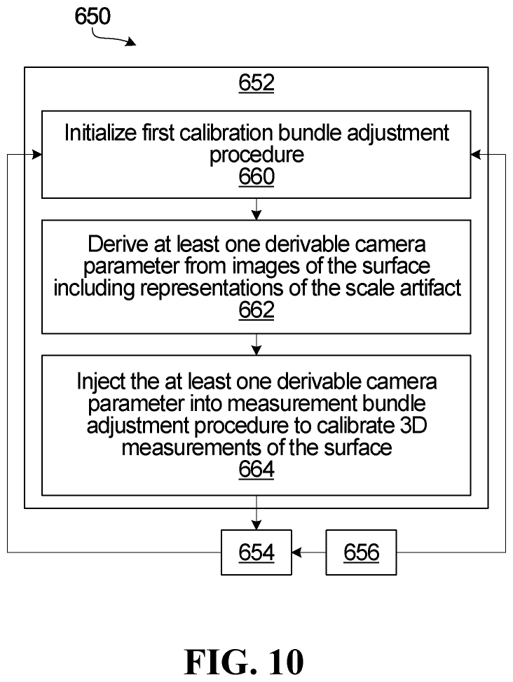

Referring back to FIG. 5, at least one of during the 3D scanning procedure (i.e., during block 506 of FIG. 6) or after the 3D scanning procedure (i.e., after block 506), the processor 400 may initiate the calibrate camera parameters procedure 650 based on images which have been captured by the first and second cameras 120 and 130 up to a particular time point (e.g., up to tₙ during the 3D scanning procedure or up to t_{end} of the 3D scanning procedure). In the embodiment shown, the calibrate camera parameters procedure 650 is performed by the processor 400 executing processor-readable instructions and/or computer-readable instructions stored in the program memory 404; in other embodiments, the calibrate camera parameters procedure 650 may comprise processor-readable instructions and/or computer-readable instructions alternatively stored on other non-transitory computer readable storage medium; in yet other embodiments, the calibrate camera parameters procedure 650 and/or parts thereof may alternatively be executed by a device other than the processor 400. Further, although the calibrate camera parameters procedure 650 in accordance with one embodiment is described with reference to the flowchart illustrated in FIG. 10, other methods of implementing the calibrate camera parameters procedure 650 may alternatively be used. For example, the order of execution of the blocks may be altered, and/or some of the blocks described may be altered, eliminated, or combined.

The calibrate camera parameters procedure 650 generally function to derive at least one derivable parameter for calibrating extrinsic and intrinsic parameters of the first and second cameras 120 and 130 by processing the same spatially neighboring frames as those processed by the determine 3D measurements process 600 described above. In some other embodiments, the calibrate camera parameters procedure 650 also calibrates at least one calibratable camera parameter by processing the same spatially neighboring frames as those processed by the determine 3D measurements process 600 described above. In other words, the same set of images of a plurality of spatially neighboring frames are used at least one of to generate 3D measurements of the surface 112, to derive the at least one derivable parameter, or to calibrate at least one calibratable camera parameter. This can remove the need for an operator of the scanner 101 to perform the pre-operation calibration procedure separately from the 3D scanning procedure and/or the pre-operation calibration procedure with the calibration object separate from the target object 110. As described below, in some embodiments, the calibrate camera parameters procedure 650 may specifically analyze images captured by the first and second camera 120 and 130 which include representations of the scale artifact 105, such as representations of the first and second physical scale features Pₐ and P_{b} of the physical scale element 300, to obtain dimension information therefrom and to derive at least one derivable parameter based on the dimension information.

Referring to FIG. 5, in some embodiments, the calibrate camera parameters procedure 650 includes a first block 652, a second block 654, and a third block 656. The first block 652 may include codes directing the processor 400 to perform a smaller first calibration bundle adjustment procedure (also referred to as the “small calibration bundle adjustment procedure” or “first calibration bundle adjustment procedure”). An embodiment of the small calibration bundle adjustment procedure is shown in equation (14), which aims to optimize a stereo pose of the first camera 120 and the second camera 130 relative to each other (e.g., optimize stereo extrinsic parameters M_{c1} or M_{c2} as described above, or simply M_{c2} in embodiments where the first camera 120 is the origin sensor of the scanner 101). The second block 654 may include codes directing the processor 400 to perform a larger second calibration bundle adjustment procedure (also referred to as the “large calibration bundle adjustment procedure” or “second calibration bundle adjustment procedure”). An embodiment of the large calibration bundle adjustment procedure is shown in equation (18), which aims to optimize other intrinsic and extrinsic parameters of the first and second cameras 120 and 130 (e.g., extrinsic parameters Mₒ, lens distortion D_{c1}, D_{c2} intrinsic parameters K_{c1}, K_{c2} as described above). The third block 656 may include codes directing the processor 400 to perform an indirect calibration bundle adjustment procedure. An embodiment of the indirect calibration bundle adjustment procedure is shown in equation (20), which aims to simultaneously optimize stereo pose, intrinsic parameters and extrinsic parameters by considering 3D measurements (P_{wai} and P_{wbi}) associated with the physical scale features Pₐ and P_{b} of the physical scale element 300 as special 3D measurements in the world reference frame 118.

One embodiment of the first block 652 is shown in FIG. 10. In the embodiment shown, the first block 652 begins at block 660, which may include codes directing the processor 400 to initialize the first calibration bundle adjustment procedure (an embodiment of which is shown in equation (14)) on the images captured by both the first and second cameras 120 and 130 up to a particular time point (e.g., up to tₙ during the 3D scanning procedure or up to t_{end} of the 3D scanning procedure). The first calibration bundle adjustment procedure of equation (14) receives initial 3D measurements P_{wi} of the surface 112, initial extrinsic parameters Mₒ of the origin point of the scanner 101 (e.g., the first camera origin 121) relative to the world reference frame 118, an initial rotation matrix Rₓ of the first and second cameras 120 and 130 (e.g., in particular R_{c2} of the second camera 130 in embodiments where the first camera origin 121 is the origin point of the scanner 101) relative to the sensor reference frame 128, and an initial θₓ,φₓ components of the translation vector tₓ of the first and second cameras 120 and 130 relative to the sensor reference frame 128 (e.g., in particular the θ_{c2},φ_{c2} components of the translation vector t_{c2} of the second camera 130 in embodiments where the first camera origin 121 is the origin point of the scanner 101), and then aims to minimize error with respect to these components as the unconstrained variables. In other words, the first calibration bundle adjustment of equation (14) aims to optimize and solve the 3D measurements P_{wi} of the surface 112, the extrinsic parameters Mₒ of the origin point of the scanner 101, the rotation matrix R_{c2} of the second camera 130, and the θ_{c2},φ_{c2} components of the translation vector t_{c2} of the second camera 130. The extrinsic parameters Mₒ, the rotation matrix Rₓ, and the θₓ,φₓ components of the translation vectors tₓ may generally be considered calibratable camera parameters. Block 660 may direct the processor 400 to retrieve the fixed (or constrained) camera parameters comprising the lens distortion Dₓ and the intrinsic parameters Kₓ from the storage memory 402 (e.g., the camera parameters data store 651, stored after a previous iteration of the second calibration bundle adjustment procedure of the second block 654 as described below). Block 660 may also direct the processor 400 to retrieve the fixed (or constrained) variables of the 2D coordinates pₓᵢ from the images captured by the first and second cameras 120 and 130.

$${arg min}_{{M}_{o} , {R}_{x} , {θ}_{x} , {φ}_{x} , {P}_{wiH}} {\sum }_{i , x , 0} ‖ d ( {p}_{x i} , {D}_{x} ) - π ( {K}_{x} {M}_{x} ( {R}_{x} , {ρ}_{x} , {θ}_{x} , {φ}_{x} ) {M}_{o} {P}_{w i H} ) ‖ 2 \qquad ( 14 )$$

whereby x ϵ {c1,c₂}, and in embodiments where the set of cameras 102 includes additional cameras c3, c4 [. . .], cn, x ϵ {c1,c₂,c₃ . . . cn}; Pₓᵢ is a distorted 2D coordinate of a particular feature i of the surface 112 in the frames captured by either the first camera 120 or the second camera 130; P_{wi} is the 3D measurements of the particular feature i in the 3D world reference frame 118

$$[ \begin{matrix}{\hat{x}}_{w} \\ {\hat{y}}_{w} \\ {\hat{z}}_{w}\end{matrix} ] ;$$

Dₓ is the lens distortion of either the first and second cameras 120 and 130 (or any additional cameras) as described above; Kₓ is the intrinsic parameters of either the first and second cameras 120 and 130 (or any additional cameras) as described above; Mₒ is the extrinsic parameters of the origin point as described above; Mₓ is the stereo extrinsic parameters of either the first and second cameras 120 and 130 (or any additional cameras) as described above; for x=c2, R_{c2} is the rotation matrix representing a rotation of the second camera reference frame 138

$$[ \begin{matrix}{\hat{x}}_{c 2} \\ {\hat{y}}_{c 2} \\ {\hat{z}}_{c 2}\end{matrix} ]$$

relative to the sensor reference frame 128 and ρ_{c2},θc2,φ_{c2} are components of the translation vector t_{c2} representing a translation of the second camera origin 131 of the second camera 130 relative to the origin point (e.g., the first camera origin 121 of the first camera 120) as described above; for x=c1, in embodiments where the the first camera origin 121 forms the origin point of the scanner 101 (e.g., in embodiments where the first camera reference frame is equivalent to the sensor reference frame 128), M_{c1} is a 4×4 identity matrix.

At block 660, the processor 400 may initialize the first calibration bundle adjustment procedure shown in equation (14) with the 3D measurements P_{wi}, the extrinsic parameters Mₒ, and the stereo extrinsic parameters Rₓ,θₓ,φₓ as unconstrained variables being minimized and solved for. However, the initialized first calibration bundle adjustment shown in equation (14) does not include minimizing or solving for the stereo extrinsic parameter ρₓ (e.g., in particular ρ_{c2} of the second camera 130 shown in FIG. 9 in embodiments where the first camera origin 121 is the origin point of the scanner 101). Rather, the stereo extrinsic parameter ρₓ is a fixed (or constrained) variable. In this respect, small errors or changes in ρₓ may correspond to an error or a change in the camera separation distance 135 (shown in FIGS. 2, 3A and 3B), and may result in significant inaccuracies in the first calibration bundle adjustment procedure. Thus, solving for ρₓ as an unconstrained variable via the first calibration bundle adjustment may result in inaccurate optimizations, which may be propagated to the calibratable camera parameters and the 3D measurements P_{wi} of the surface 112. It may instead be necessary to derive a relatively accurate ρₓ, and ρₓ may thus be considered a derivable camera parameter.

In this regard, the first block 652 may include block 662 which may include codes directing the processor 400 to derive ρₓ utilizing the dimension information associated with the scale artifact 105. For example, block 662 may direct the processor 400 to extract different instances of the scale features Pₓₐᵢ and P_{xbi} from representations of the physical scale element 300 in the images captured by the first and second cameras 120 and 130 and which match the first and second scale features Pₐ and P_{b} of the physical scale element 300. Block 662 may then direct the processor 400 to determine the 3D measurements of the first scale feature Pₐ (i.e.,

$${P}_{w a i} = [ \begin{matrix}{x}_{w a i} \\ {y}_{w a i} \\ {z}_{w a i}\end{matrix} ] ,$$

in the world reference frame 118) based the 2D coordinates of the first scale feature Pₓₐᵢ in images captured by the first and second cameras 120 and 130 in a manner similar to the determine 3D measurements process 600 described above. Similarly, block 662 may also direct the processor 400 to determine the 3D measurements of the second scale feature P_{b} (i.e.,

$${P}_{w b i} = [ \begin{matrix}{x}_{w b i} \\ {y}_{w b i} \\ {z}_{w b i}\end{matrix} ] ,$$

in the world reference frame 118) based the 2D coordinates of the second scale feature P_{xbi} in images captured by the first and second cameras 120 and 130.

Block 662 may then direct the processor 400 to determine a separation distance mᵢ between the determined 3D measurements P_{wai} and P_{wbi} as shown in equation (15).

$${m}_{i} = ‖ {P}_{w a i} - {P}_{w b i} ‖ \qquad ( 15 )$$

Block 662 may then direct the processor 400 to generate a scale factor s based on a relationship of (1) the actual separation distance rᵢ (encoded within the nominal scale element 302 for example) between the actual 3D measurements P_{wa} and P_{wb} representing the first and second physical scaling features Pₐ and P_{b} as described above in association with FIG. 4, and (2) the determined separation distance mᵢ between the determined 3D measurements P_{wai} and P_{wbi} (determined from 2D coordinates of the first and second scale features pₓₐᵢ and p_{xbi} in the image reference frame(s)) as shown in equation (16).

$$s = \frac{{\sum }_{N} {m}_{i} {r}_{i}}{{\sum }_{N} {m}_{i}^{2}} \qquad ( 16 )$$

As described above, the actual separation distance rᵢ between the actual 3D measurements P_{wa} and P_{wb} may correspond to the actual physical linear length 304 of the physical scale element 300 encoded within the nominal scale element 302. In contrast, the determined separation distance mᵢ between the determined 3D measurements P_{wai} and P_{wbi} correspond to a distance determined utilizing the images captured by the first and second cameras 120 and 130. The relationship (represented by the scale factor s) between the actual separation distance rᵢ and the determined separation distance mᵢ may thus represent (or correspond) to a relationship between actual physical distances of 3D measurements in the world reference frame 118 and determined distances of 3D measurements generated from 2D coordinates of images captured by the first and second cameras 120 and 130. This scale factor s may be used to scale an initialized ρₓ (e.g., in particular ρ_{c2} shown in FIG. 9 in embodiments where the first camera origin 121 is the origin point of the scanner 101) as shown in equation (17). The initialized ρₓ may be retrieved from the camera parameters data store 651 the storage memory 402, and may be a value which is initially factory set at manufacture of the scanner 101 and/or a previous scaled

$${ρ}_{x}^{′}$$

determined via a previous plock 662 and stored in the camera parameters data store 651.

$${ρ}_{x}^{′} = s {ρ}_{x} \qquad ( 17 )$$

After determining the scaled

$${ρ}_{x}^{′} ,$$

the first block 652 may continue to block 664, which may include codes directing the process 400 to reintroduce the scaled

$${ρ}_{x}^{′}$$

into the measurement bundle adjustment procedures as shown in equation (13) performed by the determine 3D measurements process 600 as fixed variable or as a more contrained variable. The scaled

$${ρ}_{x}^{′}$$

may be used to more effectively calibrate/minimize error with respect 3D measurement P_{wi} of the surface 112 and the extrinsic parameters Mₒ of the origin point. An embodiment of the measurement bundle adjustment outline injection of the calibrated

$${ρ}_{x}^{′}$$

is shown in equation (13a). Block 664 may also include codes directing the processor 400 to reintroduce the scaled

$${ρ}_{x}^{′}$$

into the first calibration bundle adjustment procedure as shown in equation (14) performed by the calibrate camera parameters process 650 as a fixed variable or as a more constrained variable. An embodiment of the first calibration bundle adjustment procedure outlining injection of the calibrated

$${ρ}_{x}^{′}$$

is shown in equation (14a):

$${arg min}_{{M}_{o} , {P}_{wiH}} {\sum }_{i , x , o} {‖ d ( {p}_{x i} , {D}_{x} ) - π ( {K}_{x} {M}_{x} ( {R}_{x} , {ρ}_{x}^{′} , {θ}_{x} , {φ}_{x} ) {M}_{o} {P}_{w i H} ) ‖}^{2} \qquad ( 13 a )$$

$${arg min}_{{M}_{o} , {R}_{x} , {θ}_{x} , {φ}_{x} , {P}_{wiH}} {\sum }_{i , x , o} {‖ d ( {p}_{x i} , {D}_{x} ) - π ( {K}_{x} {M}_{x} ( {R}_{x} , {ρ}_{x}^{′} , {θ}_{x} , {φ}_{x} ) {M}_{o} {P}_{w i H} ) ‖}^{2} \qquad ( 14 a )$$

$${ρ}_{x}^{′}$$

$${ρ}_{x}^{′}$$

shown in equations (16) and (17) during the 3D scanning procedure (i.e., during block 506 shown in FIG. 6) using images captured, and initial 3D measurements determined, up to a current tₙ during the 3D scanning procedure. This can allow the scaled

$${ρ}_{x}^{′}$$

to be injected into measurement bundle adjustment procedures performed during a particular 3D scanning procedure for more accurate future 3D measurements of the surface 112 during that particular 3D scanning procedure. For example, the processor 400 may execute the first block 652 while images of the plurality of spatially neighboring frames are being processed with the processor 400 to generate the 3D measurements of the surface 112, or while the first and second cameras 120 and 130 are still capturing additional images of the plurality of spatially neighboring frames. Additionally, the first block 652 may be executed more than one time during a particular 3D scanning procedure. For example, the first block 652 may be continuously executed by the processor 400 in the background (i.e., the processor 400 may analyze every image captured by the first and second cameras 120 and 130 and perform the first block 652 thereon). As an additional example, the first block 652 may be executed by the processor 400 at intervals, such as after a particular amount of time has passed and/or after a particular number of images and/or frames have been captured by the first and second cameras 120 and 130. In such embodiments, the first block 652 may be a concurrent calibration procedure of at least one camera parameter.

In other embodiments, first block 652 may be performed after the 3D scanning procedure (i.e., after block 506). In such embodiments, the first block 652 may instead be a post-operation calibration procedure of at least one camera parameter. For example, the processor 400 may execute the first block 652 after the plurality of spatially neighboring frames are processed with the processor 400 to generate the 3D measurements of the surface 112, or after the first and second cameras 120 and 130 have captured images of the plurality of spatially neighboring frames.

Further, after a particular instance of the first block 652, the processor 400 may store the stereo extrinsic parameters Rₓ,θₓ,φₓ optimized utilizing the first calibration bundle adjustment procedure (e.g., the first calibration bundle adjustment procedure shown in equation (14)), the scale factor s determined utilizing equations (16) and (17), and the scaled stereo extrinsic parameter

$${ρ}_{x}^{′}$$

in the camera parameters data store 651 for future use. For example, the stored stereo extrinsic parameters may be injected into further measurement bundle adjustment procedures as shown in equation (13(a)), into further first calibration bundle adjustment procedures as shown in equation (14(a)) and into further second calibration bundle adjustment procedures as shown in equation (18) as described below for example.

Referring back to FIG. 5, in some embodiments, the second block 654 may include codes directing the processor 400 to initialize the second calibration bundle adjustment procedure (an embodiment of which is shown in equation (18)) on the images captured by both the first and the second cameras 120 and 130 up to a particular time point (e.g., up to tₙ during the 3D scanning procedure or up to t_{end} of the 3D scanning procedure). The second calibration bundle adjustment of equation (18) receives initial 3D measurements P_{wi} of the surface 112, initial extrinsic parameters Mₒ, an initial lens distortion Dₓ and initial intrinsic parameters Kₓ and aims to minimize error with respect to these components as the unconstrained variables. In other words, the second calibration bundle adjustment procedure of equation (18) aims to optimize and solve the 3D measurements P_{wi} of the surface 112, the extrinsic parameters Mₒ of the origin point (e.g., the first camera origin 121), the lens distortion D_{c1}, D_{c2} of the first and second cameras 120 and 130 and the intrinsic parameters K_{c1}, K_{c2} of the first and second cameras 120 and 130. The extrinsic parameters Mₒ, the lens distortion D_{c1}, D_{c2} and the intrinsic parameters K_{c1}, K_{c2} may thus generally be considered calibratable camera parameters. The second block 654 may direct the processor 400 to retrieve the fixed (or constrained) camera parameters comprising the stereo extrinsic parameters Mₓ from the storage memory 402 (e.g., the camera parameters data store 651, stored after a previous iteration of the first calibration bundle adjustment procedure of the first block 652 as described above). Accordingly, in some embodiments, the stereo extrinsic parameters Mₓ includes the scaled

$${ρ}_{x}^{′}$$

generated from the dimension information of the scale artifact 105 by the first block 652. The second block 654 may also direct the processor 400 to retrieve the fixed (or constrained) variables of the 2D coordinates Pₓᵢ from the images captured by the first and second cameras 120 and 130.

$${arg min}_{{K}_{x} , {D}_{x} , {M}_{o} , {P}_{wiH}} {\sum }_{i , x , o} {‖ d ( {p}_{x i} , {D}_{x} ) - π ( {K}_{x} {M}_{x} {M}_{o} {P}_{w i H} ) ‖}^{2} \qquad ( 18 )$$

whereby x ϵ {c1,c2}, and in embodiments where the set of cameras 102 includes additional cameras c3, c4 [. . .], cn, x ϵ {c1,c2 ,c3 . . . cn}; Pₓᵢ is a distorted 2D coordinate of a particular feature i in the frames captured by either the first camera 120 or the second camera 130; P_{wi} is the 3D measurements of the particular feature i in the 3D world reference frame 118; Dₓ is the lens distortion of either the first and second cameras 120 and 130 (or any additional cameras) as described above; Kₓ is the intrinsic parameters of either the first and second cameras 120 and 130 (or any additional cameras) as described above; Mₒ is the extrinsic parameters of the origin point as described above; Mₓ is the stereo extrinsic parameters of either the first and second cameras 120 and 130 (or any additional cameras) as described above; and whereby for x=c1, in embodiments where the first camera 120 forms the origin sensor and the first camera origin 121 forms the origin point (e.g., in embodiments where the first camera reference frame is equivalent to the sensor reference frame 128), M_{c1} is a 4×4 identity matrix.

In the embodiment shown, the calibrate camera parameters procedure 650 may direct the processor 400 to execute the second block 654 including the second calibration bundle adjustment procedure (e.g., the second calibration bundle adjustment procedure shown in equation (18)) after the 3D scanning procedure (i.e., after block 506 of FIG. 6). In such embodiments, the second block 654 may be a post-operation calibration procedure of at least one camera parameter. For example, the processor 400 may execute the second block 654 after the plurality of spatially neighboring frames are processed with the processor 400 to generate the 3D measurements of the surface 112, or after the first and second cameras 120 and 130 have captured images of the plurality of spatially neighboring frames.

However, in other embodiments, the calibrate camera parameters procedure 650 may execute the second block 654 during the 3D scanning procedure (i.e., during block 506) using images captured, and initial 3D measurements determined, up to a current tₙ during the 3D scanning procedure. For example, the processor 400 may execute the second block 654 while images of the plurality of spatially neighboring frames are being processed with the processor 400 to generate the 3D measurements of the surface 112, or while the first and second cameras 120 and 130 are still capturing additional images of the plurality of spatially neighboring frames. Additionally, the second block 654 may be executed more than one time during a particular 3D scanning procedure. For example, the second block 654 may be continuously executed by the processor 400 in the background. As an additional example, the second block 654 may be executed by the processor 400 at intervals, such as after a particular amount of time has passed and/or after a particular number of images and/or frames have been captured by the first and second cameras 120 and 130. In such embodiments, the second block 654 may be a concurrent calibration procedure of at least one camera parameter.

Further, after a particular instance of the second block 654, the processor 400 may store the lens distortion D_{c1}, D_{c2} of the first and second cameras 120 and 130 and the intrinsic parameters K_{c1}, K_{c2} of the first and second cameras 120 and 130 optimized utilizing the second calibration bundle adjustment procedure (e.g., the second calibration bundle adjustment procedure shown in equation (18)) in the camera parameters data store 651 for future use. For example, the stored lens distortion and stored intrinsic parameters may be injected into further measurement bundle adjustment procedures as shown in equation (13(a)) and further first calibration bundle adjustment procedures as shown in equation (14) as described above for example.

Referring back to FIG. 5, in some embodiments, the third block 656 may include codes directing the processor 400 to initialize the indirect calibration bundle adjustment procedure (an embodiment of which is shown in equation (20)) on the images captured by both the first and the second cameras 120 and 130 up to a particular time point (e.g., up to tₙ during the 3D scanning procedure or up to t_{end} of the 3D scanning procedure). The indirect calibration bundle adjustment of equation (20) aims to simultaneously minimize error with respect to the 3D measurements P_{wi} of the surface 112, the extrinsic parameters Mₒ of the first camera 120, the lens distortion D_{c1}, D_{c2}, intrinsic parameters K_{c1}, K_{c2}, the rotation matrix Rₓ of the first and second cameras 120 and 130 (e.g., in particular R_{c2} of the second camera 130 in embodiments where the first camera origin 121 is the origin point of the scanner 101), and the θₓ,φₓ components of the translation vector tₓ of the first and second cameras 120 and 130 (e.g., in particular θ_{c2},φ_{c2} of the second camera 130 in embodiments where the first camera origin 121 is the origin point of the scanner 101) by directly considering the determined 3D measurements P_{wai} of the first physical scale feature Pₐ and the determined 3D measurements P_{wbi} of the first second physical scale feature P_{b} as special 3D measurements.

For example, the determined 3D measurements P_{wai} of the first physical scale feature Pₐ and the determined 3D measurements P_{wbi} of the second physical scale feature P_{b} may be written as a vector function of each other using spherical coordinates based in the world reference frame 118 as shown in equation (19).

$${P}_{w b i} ( {P}_{w a i} , {ρ}_{w i} , {θ}_{w i} , {φ}_{w i} ) = {P}_{w a i} + [ \begin{matrix}{ρ}_{wi} sin ( {θ}_{w i} ) cos ( {φ}_{w i} ) \\ {ρ}_{wi} sin ( {θ}_{w i} ) sin ( {φ}_{w i} ) \\ {ρ}_{w i} cos ( {θ}_{w i} )\end{matrix} ] \qquad ( 19 )$$

whereby P_{wai} is the determined 3D measurements of the first scale feature Pₐ in the world reference frame 118; P_{wbi} is the determined 3D measurements of the second scale feature P_{b} in the world reference frame 118; ρ_{wi},θ_{wi},φ_{wi} are components of a translation vector t_{ab} representing a translation of P_{wai} relative to P_{wbi} in the world reference frame 118

$$[ \begin{matrix}{\hat{x}}_{w} \\ {\hat{y}}_{w} \\ {\hat{z}}_{w}\end{matrix} ] ,$$

and specifically whereby ρ_{wi} is a length of remapped separation distance between P_{wai} and P_{wbi} in the \hat{x}_{w}ŷ_{w} plane; φ_{wi} is an angle of the remapped separation distance in the \hat{x}_{w}ŷ_{w} plane relative to \hat{x}_{w}; and θ_{wi} is an angle of the translation vectior t_{ab} relative to to \hat{z}_{w}.

ρ_{wi} may generally correspond to the determined separation distance mᵢ between P_{wai} and P_{wbi} and also may be equivalent to, and/or is a function of, the actual separation distance rᵢ between between the actual 3D measurements P_{wa} and P_{wb} representing scale feature Pₐ and P_{b}. As described above, the actual separation distance rᵢ may be known to correspond to the actual physical linear length 304 of the physical scale element 300 between Pₐ and P_{b} (e.g., encoded within the nominal scale element 302).

With the above formulation and with ρ_{wi} being equivalent to the actual separation distance rᵢ between the actual 3D measurements P_{wa} and P_{wp} in the word reference frame 118, ρ_{wi} may be introduced into the indirect bundle calibration adjustment procedure shown in equation (20) as a fixed variable or a constrained variable. In particular, the ρ_{wi} being equivalent to the actual separation distance rᵢ may be introduced as a part of the definition of determined 3D measurement P_{wbi} corresponding to the scale feature P_{b}. The indirect bundle adjustment procedure may be used to simultaneously minimize error with respect to the 3D measurements P_{wi} of the surface 112, 3D measurements P_{wai} of the first feature Pₐ, the extrinsic parameters Mₒ of the origin point (e.g., first camera origin 121), the lens distortion D_{c1}, D_{c2}, the intrinsic parameters K_{c1}, K_{c2}, the rotation matrix Rₓ of the first and second cameras 120 and 130, and the θ_{wi},φ_{wi} components of the translation vector t_{ab}.

$${arg min}_{{{M}_{o} , {P}_{wiH} , {P}_{waiH} ,}_{{θ}_{wi} , {φ}_{wi} , {K}_{x} , {M}_{x} , {D}_{x}}} {\sum }_{i , x , o} {‖ d ( {u}_{xi} , {D}_{x} ) - π ( {K}_{x} {M}_{x} {M}_{o} {U}_{wi} ) ‖}^{2} \qquad ( 20 )$$

whereby

$${U}_{w i} ∈ \{ \begin{matrix}{P}_{wiH} \\ {P}_{waiH} \\ {{P}_{wbi} ( {P}_{wai} , {r}_{i} , {θ}_{wi} , {φ}_{wi} )}_{H}\end{matrix}$$

and represents the 3D measurements in the world reference frame 118 (both of the surface 112 (P_{wi}) and of the first and second features (Pₐ and P_{b} (P_{wai} and P_{wbi})) as determined from corresponding 2D coordinates of features in the images captured by the first and second cameras 120 and 130;

$${u}_{x i} ∈ \{ \begin{matrix}{p}_{xi} \\ {p}_{xai} \\ {p}_{xbi}\end{matrix}$$

and represents the 2D coordinates in images captured by the first and second cameras 120 and 130 (again, both of the surface 112 (Pₓᵢ) and of the first and second features Pₐ and P_{b} (Pₓₐᵢ and P_{xbi})); x ϵ {c1, c2}, and in embodiments where the set of cameras 102 includes additional cameras c3, c4 [. . .], cn, x ϵ {c1,c2,c3 . . . cn}; Dₓ is the lens distortion of either the first and second cameras 120 and 130 (or any additional cameras) as described above; Kₓ is the intrinsic parameters of either the first and second cameras 120 and 130 (or any additional cameras) as described above; Mₒ is the extrinsic parameters of the origin point relative to the world reference frame 118 as described above; Mₓ is the stereo extrinsic parameters of either the first and second cameras 120 and 130 (or any additional cameras) as described above; and whereby for x=c1, in embodiments where the first camera 120 forms the origin sensor and the first camera origin 121 forms the origin point (e.g., in embodiments where the first camera reference frame is equivalent to the sensor reference frame 128), M_{c1} is a 4×4 identity matrix.

In this respect, even though the separation distance rᵢ (e.g., the actual physical linear length 304) between Pₐ and P_{b} is being considered as a portion of a 3D coordinate P_{wbi} corresponding to the scale feature P_{b}, the indirect bundle calibration adjustment procedure in equation (20) may still sufficiently account for the separation distance r₁ during optimization of the 3D measurements.

In the embodiment shown, the calibrate camera parameters procedure 650 may perform the third block 656 including the indirect calibration bundle adjustment procedure shown in equation (20) after the 3D scanning procedure (i.e., after block 506 shown in FIG. 6). In such embodiments, the third block 656 may be a post-operation calibration procedure of at least one camera parameter. For example, the processor 400 may execute the third block 656 after the plurality of spatially neighboring frames are processed with the processor 400 to generate the 3D measurements of the surface 112, or after the first and second cameras 120 and 130 have captured images of the plurality of spatially neighboring frames. However, in other embodiments, the calibrate camera parameters procedure 650 may execute the third block 656 during the 3D scanning procedure (i.e., during block 506) and may execute the third block 656 more than one time during a particular 3D scanning procedure. For example, the processor 400 may execute the third block 656 while images of the plurality of spatially neighboring frames are being processed with the processor 400 to generate the 3D measurements of the surface 112, or while the first and second cameras 120 and 130 are still capturing additional images of the plurality of spatially neighboring frames. As an additional example, the third block 656 may be continuously executed by the processor 400 in the background. As an additional example, the third block 656 may be executed by the processor 400 at intervals, such as after a particular amount of time has passed and/or after a particular number of images and/or frames have been captured by the first and second cameras 120 and 130. In such embodiments, the second block 654 may be a concurrent calibration procedure of at least one camera parameter.

Further, after a particular instance of the third block 656, the processor 400 may store the stereo extrinsic parameters Mₓ of the first and second cameras 120 and 130 (e.g., in particular M_{c2} of the second camera 130 in embodiments where the first camera origin 121 is the origin point of the scanner 101), the lens distortion D_{c1}, D_{c2} of the first and second cameras 120 and 130 and the intrinsic parameters K_{c1}, K_{c2} of the first and second cameras 120 and 130 optimized utilizing the indirect calibration bundle adjustment procedure (e.g., the indirect calibration bundle adjustment procedure shown in equation (20)) in the camera parameters data store 651 for future use. For example, the stored camera parameters may be injected into further measurement bundle adjustment procedures as shown in equation (13(a)), into further first calibration bundle adjustment procedures as shown in equation (14a) and into further second calibration bundle adjustment procedures as shown in equation (18) for example.

### Calibrate Projector Parameters Procedure 700

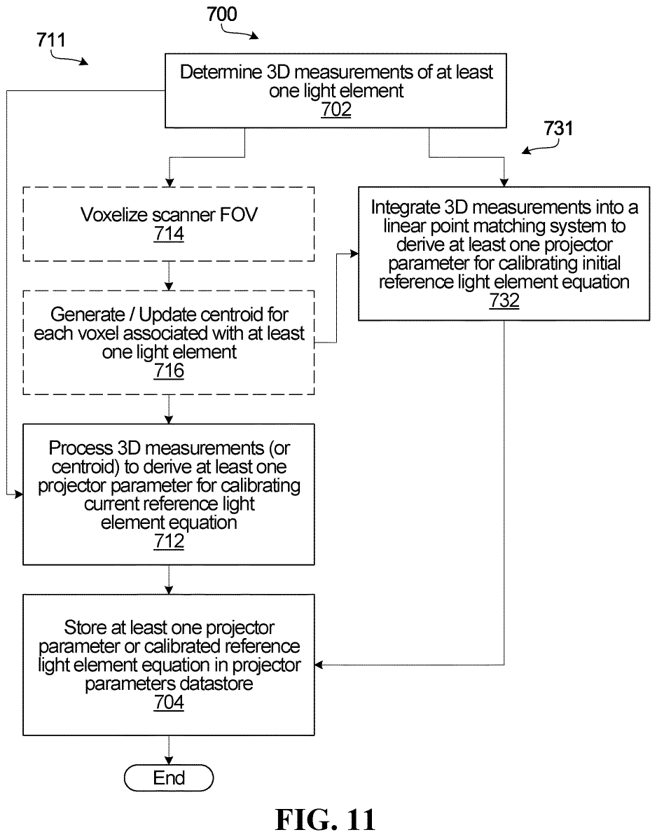

At least one of during the 3D scanning procedure (i.e., during block 506 shown in FIG. 6) and/or after the 3D scanning procedure (i.e., after block 506), the processor 400 may initiate the calibrate projector parameters procedure 700 based on frames which have been captured by the first and second cameras 120 and 130 up to a particular time point (e.g., up to tₙ during the 3D scan or up to t_{end} of the 3D scan). In the embodiment shown, the calibrate projector parameters procedure 700 is performed by the processor 400 executing processor-readable instructions and/or computer-readable instructions stored in the program memory 404; in other embodiments, the calibrate projector parameters procedure 700 may comprise processor-readable instructions and/or computer-readable instructions alternatively stored on other non-transitory computer readable storage medium; in yet other embodiments, the calibrate projector parameters procedure 700 and/or parts thereof may alternatively be executed by a device other than the processor 400. Further, the calibrate projector parameters procedure 700 is explained below with reference to the plurality of light planes 230 projected by the first top projector 222. However, those skilled in the art will appreciate that the below description would also be applicable to the plurality of light planes projected by the projectors 224, 226 or 228. Further, although the calibrate projector parameters procedure 700 in accordance with one embodiment is described with reference to the flowchart illustrated in FIG. 11, other methods of implementing the calibrate projector parameters procedure 700 may alternatively be used. For example, the order of execution of the blocks may be altered, and/or some of the blocks described may be altered, eliminated, or combined. The calibrate projector parameters procedure 700 may be performed independently of, or in conjunction with, the calibrate camera parameters procedure 650 described above. In embodiments where the calibrate projector parameters procedure 700 is performed independently of the calibrate camera parameters procedure 650, the target object 110 may not have any scale artifact 105 fixedly associated with the target object 110.

In the one embodiment shown, the calibrate projector parameters procedure 700 may involve a first branch 711 including (a) determining 3D measurements of at least one light plane of the plurality of light planes 230 proiected by the projector 222 within the sensor reference frame 128

$$[ \begin{matrix}{\hat{x}}_{o} \\ {\hat{y}}_{o} \\ {\hat{z}}_{o}\end{matrix} ] ,$$

(b) grouping the 3D measurements of the at least one light plane into a plurality centroids, each centroid of the plurality of centroids representing a collapsed version of a subset of the 3D measurements of the at least one plane of the plurality of light planes 230, (c) processing the plurality of centroids to derive at least one projector parameter and (d) calibrate a reference light plane equation representing the at least one light plane with the derived at least one projector parameter to generate a calibrated light plane equation. The current reference light plane equation may correspond to an initial reference light plane equation initially loaded at a beginning of a particular 3D scanning procedure (i.e., at a beginning of block 506) or may correspond to a current reference light plane equation previously calibrated during a particular 3D scanning procedure (i.e., during block 506). The calibrated reference light plane equation and/or the at least one projector parameter may then be stored in the projector parameters datastore 701 and may be used by the processor 400 in the determine 3D measurements process 600 to generate further 3D measurements of the surface 112. The first branch 711 may be executed a plurality of times during a particular 3D scanning procedure.

In another embodiment, the calibrate projector parameters procedure 700 may instead involve a second branch 731 including (a) determining 3D measurements of at least one light plane of the plurality of light planes 230 projected by the projector 222 within the sensor reference frame 128

$$[ \begin{matrix}{\hat{x}}_{o} \\ {\hat{y}}_{o} \\ {\hat{z}}_{o}\end{matrix} ] ,$$

(b) integrating the 3D measurements of the at least one light plane of the plurality of light planes 230 of the projector 222 to an linearized point matching system, (c) processing the linearized point matching system to derive at least one projector parameter and (d) calibrating an initial reference light plane equation representing the at least one light plane with the derived at least one projector parameter to generate a calibrated reference light plane equation. The initial reference light plane equation may correspond to an initial reference light plane equation initially loaded at a beginning of a particular 3D scanning procedure (i.e., at a beginning of block 506). The calibrated reference light plane equation and/or the at least one projector parameter may then be stored in the projector parameters datastore 701 and may be used by the processor 400 in the determine 3D measurements process 600 to generate further 3D measurements of the surface 112. The second branch 731 may be executed a plurality of times during a 3D scanning procedure, and in some embodiments, each iteration of the second branch 731 may be performed on the initial reference light plane equation initially loaded at the beginning of (i.e., at a beginning of block 506).

The second branch 731 may be used in embodiments where the at least one projector parameter (i.e., the difference between the initial reference light plane equation and the calibrated reference light plane equation) is relatively small. Additionally, in some embodiments, the calibrate projector parameters procedure 700 may initially perform the second branch 731 to determine the at least one projector parameter, but may default back to performing the first branch 711 when the at least one projector parameter determined using the second branch 731 is too large or when a condition number associated with the linearized point matching system indicates that the linearized point matching system is not stable, for example.

The calibrate projector parameters procedure 700 derive the at least one projector parameter for calibrating the reference light plane equation representing the at least one light plane 230 by processing the same frames captured by the first and second cameras 120 and 130 as those used by the determine 3D measurements process 600 described above. In other words, the same set of images are used to generate 3D measurements of the surface 112 and to generate the 3D measurements of the at least one light plane 230 derive the at least one projector parameter. This can remove the need for the operator of the scanner 101 to perform the pre-operation calibration procedure separate from the 3D scanning procedure and/or the pre-operation calibration procedure with the calibration object separate from the target object 110. As described above, the initial, the current and the calibrated reference light plane equations representing the at least one light plane 230 may be used to define a position of the corresponding at least one light plane 230 in the scanner and second camera reference frames 128 and 138, and may thus be used to extract and match the at least one light line 232 resolving from the at least one light plane 230 on the surface 112 as between different images of a particular frame. The initial, the current and the calibrated reference light plane equation may thus be used to generate the 3D measurements of the surface 112.

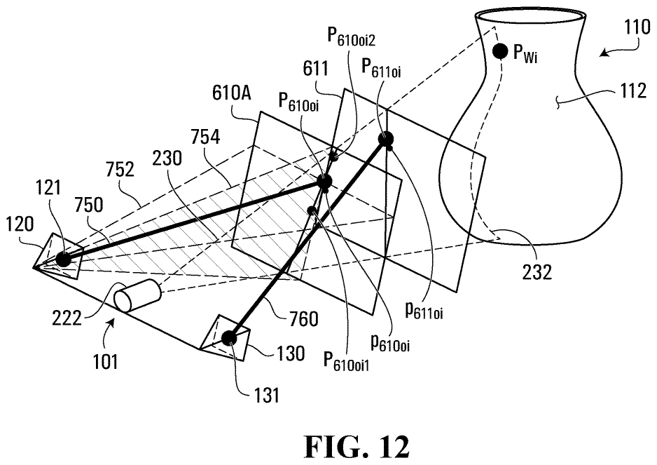

In the embodiment shown in FIGS. 11 and 12, the calibrate projector parameters procedure 700 begins at block 702, which may include codes for directing the processor 400 to determine 3D measurements of the light planes 230 projected by the projector 222 using the first image 610A captured by the first camera 120 and the second image 611 captured by the second camera 130. For example, block 702 may direct the processor 400 to extract and match features (e.g., P₁₀ₒᵢ and P₆₁₁ₒᵢ shown in FIG. 12) corresponding to representations of the light line 232 formed on the surface 112 from the images 610A and 611. Block 702 may then direct the processor 400 to generate initial 3D measurements for the light planes 230 (e.g., P₆₁₀ₒᵢ and P₆₁₁ₒᵢ shown in FIG. 12) from the features of the light lines 232 within the images 610A and 611 within the sensor reference frame 128

$$[ \begin{matrix}{\hat{x}}_{o} \\ {\hat{y}}_{o} \\ {\hat{z}}_{o}\end{matrix} ] ,$$

rather than the world reference frame 118

$$[ \begin{matrix}{\hat{x}}_{w} \\ {\hat{y}}_{w} \\ {\hat{z}}_{w}\end{matrix} ] ,$$

utilizing a corresponding reference light plane equation defining a reference position of the light planes 230 within the sensor reference frame 128 (e.g., equation (1) described above) in a manner known to those skilled in the art. For example, block 702 may direct the processor 400 to triangulate the 3D measurements of the light planes 230 via a bundle adjustment procedure shown in equation (21). The projector bundle adjustment procedure of equation (21) may aim to minimize error with respect to the 3D measurements of the light plane 230 (Pₒᵢ) within the sensor reference frame 128, and may utilize Dₓ, Kₓ and Mₓ values determined via a previous calibrate camera parameters procedure 650.

$${arg min}_{{P}_{oiH}} {\sum }_{x} {‖ d ( {p}_{x i} , {D}_{x} ) - π ( {K}_{x} {M}_{x} {P}_{o i H} ) ‖}^{2} \qquad ( 21 )$$

whereby x ϵ {c1, c2}, and in embodiments where the set of cameras 102 includes additional cameras c3, c4 [. . .], cn, x ϵ {c1, c2, c3 . . . cn}; Pₓᵢ is a distorted 2D coordinate of a particular point i corresponding to a representation of at least one light line 232 in an image captured by the first camera 120 or the second camera 130 (e.g., P₆₁₀ₒᵢ and P₆₁₁ₒᵢ shown in FIG. 12) or any additional cameras; Pₒᵢ is the 3D measurements of that particular point i in the sensor reference frame 128

$$[ \begin{matrix}{\hat{x}}_{o} \\ {\hat{y}}_{o} \\ {\hat{z}}_{o}\end{matrix} ]$$

(e.g., P₆₁₀ₒᵢ and P₆₁₁ₒᵢ shown in FIG. 12), and generally correspond to the 3D measurement of the at least one light plane 230 which resolves as the at least one light line 232 in the images; Dₓ is the lens distortion of either the first and second cameras 120 and 130 (or any additional cameras) as described above; Kₓ is the intrinsic parameters of either the first and second cameras 120 and 130 (or any additional cameras) as described above; Mₓ is the stereo extrinsic parameters of either the first and second cameras 120 and 130 (or any additional cameras) as described above; and whereby for x=c1, in embodiments where the first camera 120 forms the origin sensor and the first camera origin 121 forms the origin point (e.g., in embodiments where the first camera reference frame is equivalent to the sensor reference frame 128), M_{c1} is a 4×4 identity matrix.
First Branch 711: Group 3D Measurements into a Plurality of Centroids

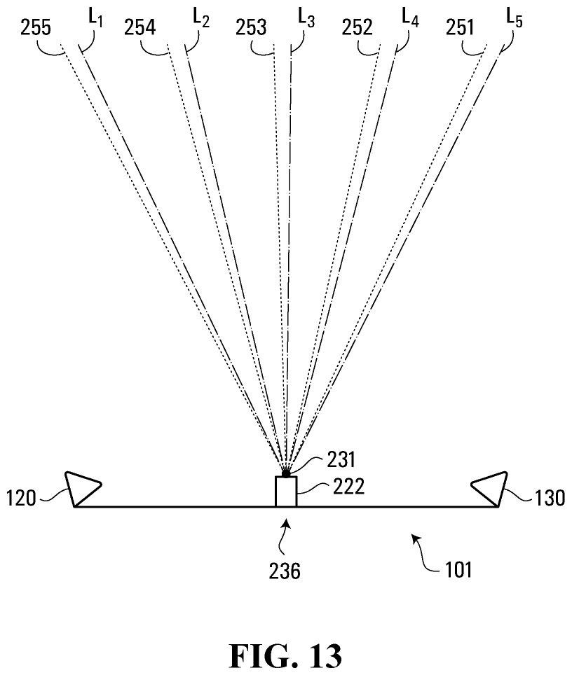

In some embodiments, the calibrate projector parameters procedure 700 may then proceed down the first branch 711. In the embodiment shown, the first branch 711 includes block 712, which may include codes directing the processor 400 to process the 3D measurements of the light planes 230 determined at block 702 to derive at least one projector parameter to adjust/calibrate an initial reference light plane equation or a previously calibrated reference light plane equation. In some embodiments, the first branch 711 may specifically direct the processor 400 to utilize an iterative closest point (ICP) algorithm shown in equations (22) and (23) to align the 3D measurements of light planes 230 determined at block 702 to a light projector model including reference light planes L₁,L₂,L₃,L₄,L₅ (shown in FIG. 13) representing an initially calibrated pose or a previously calibrated pose of those light planes 230. Although five reference light planes corresponding to the first to fifth light planes 251-255 are shown in FIG. 13, those skilled in the art would recognize that a number of reference light planes associated with a particular light projector model will correspond to a number of light planes (or other light elements) projected by the corresponding projector. More specifically, as described above in equation (1) (reproduced again below), each of the reference light planes L₁,L₂,L₃,L₄,L₅ may be represented by a respective initial reference light plane equation delineating an initial pose of a corresponding light plane 230 within the sensor reference frame 128 (e.g., the initial reference light plane equation) or a previously calibrated pose of a corresponding the light plane 230 within the sensor reference frame 128 (e.g., the current reference light plane equation).

$$A {x}_{o} + B {y}_{o} + C {z}_{o} + {d}_{o} = 0 \qquad ( 1 )$$

The ICP algorithms shown in equations (22) and (23) may allow both a projector rotation matrix Rₚ (representing a rotation of the 3D measurements of the light planes 230 determined at block 702 relative to the initial or current reference light plane equations within the sensor reference frame 128), and a projector translation vector tₚ (representing a translation of the 3D measurements of the light planes 230 determined at block 702 relative to the initial or current reference light plane equations within the sensor reference frame 128) to be determined. Equation (22) describes a point-to-plane ICP algorithm.

$${{arg min}_{{R}_{p} , {t}_{p} , {s}_{p}} {\sum }_{i = 1}^{N} ( ( {s}_{p} {R}_{p} {P}_{oi} + {t}_{p} ) - {Q}_{oi} ) \cdot {n}_{oi} )}^{2} \qquad ( 22 )$$

whereby N is the total number of 3D measurements of a particular feature i in images captured by the first and second cameras 120 and 130; sₚ is a scaling variable fixing factors associated with a reference light plane Lᵢ which may account for small uniform deformations in the reference light plane; Pₒᵢ is the 3D measurements of the particular feature i in the sensor reference frame 128

$$[ \begin{matrix}{\hat{x}}_{o} \\ {\hat{y}}_{o} \\ {\hat{z}}_{o}\end{matrix} ]$$

(e.g., P₆₁₀ₒᵢ and P₆₁₁ₒᵢ shown in FIG. 12), and generally corresponds to the 3D measurement of the light planes 230; Qₒᵢ is the 3D measurements of any point in the reference light plane Lᵢ in the sensor reference frame 128 (determined based on the initial or the current reference light plane equations), and may be a closest point in the reference light plane Lᵢ to Pₒᵢ; nₒᵢ is a normal vector of the reference light plane Lᵢ; Rₚ is the projector rotation matrix for rotating Pₒᵢ to fit Qₒᵢ; tₚ is the projector translation vector for translating Pₒᵢ to fit Qₒᵢ; and whereby the reference light plane Lᵢ is a closest reference light plane to Pₒᵢ of the plurality of reference light planes of a particular a light projector model.

In some other embodiments, equation (22) may be further constrained by known parameters associated with the first and second cameras 120 and 130. This constraint may prevent the 3D measurements of the light planes 230 from moving along the refence light plane Lᵢ to infinity. Referring back to FIG. 12, a first image ray 750 emanating from the first camera origin 121 of the first camera 120 to the p₆₁₀ₒᵢ in the first image 610A captured by the first camera 120 may be determined in a manner similar to that described above in association with FIG. 7. Then a first arbitrary plane 752 and a second arbitrary plane 754 perpendicular to the first arbitrary plane 752, may be defined for the first image ray 750. Similar arbitrary planes (not shown) may be defined for a second image ray 760 emanating from the second camera origin 131 of the second camera 130 to the P₆₁₁ₒᵢ in the second image 611 captured by the second camera 130. In some embodiments, at least one of the first and second arbitrary planes 752 and 754 associated with the first image ray 750 and at least one of the arbitrary planes associated with the second image ray 760 may be perpendicular to the baseline of the scanner 101 between the first and second cameras 120 and 130. Equation (22) may then be further constrained by the arbitrary planes 752 and 754 associated with the first image ray 750 and the arbitrary planes associated with the second image ray 760 to result in equation (22a).

$${arg min}_{{R}_{p} , {t}_{p} , {s}_{p}} {\sum }_{i = 1}^{N} \begin{matrix}( ( {s}_{p} {R}_{p} {P}_{oi} + {t}_{p} ) - {Q}_{oi} ) \cdot {n}_{oi} + \\ {{\sum }_{j = 1}^{M} ( {s}_{p} {R}_{p} {P}_{oi} + {t}_{p} ) - {G}_{oij} ) \cdot {h}_{oij} )}^{2}\end{matrix} \qquad ( 22 a )$$

whereby N, sₚ, Pₒᵢ, Qₒᵢ, Rₚ and tₚ are discussed previously in association with equation (22) above; M is the total number of arbitrary planes associated with a ray emanating from the first and second camera origins 121 and 131 of the first and second cameras 120 and 130 to a particular feature i in images captured by the first and second cameras 120 and 130; Gₒᵢⱼ is the 3D measurements of any point on the arbitrary planes in the sensor reference frame 128, and may be a closest point on the arbitrary plane to Pₒᵢ; and hₒᵢⱼ is a normal vector of the arbitrary plane.

In some embodiments, M=4, which generally corresponds to the first and second arbitrary planes 752 and 754 defined for the first image ray 750 and the first and second arbitrary planes defined for the second image ray 760 for a particular feature i. In such embodiments, the projector rotation matrix Rₚ and a projector translation vector tₚ is constrained such that a particular 3D measurement Pₒᵢ for that particular feature i must be within the first and second camera FOVs 123 and 133 as defined within the sensor reference frame 128. In other embodiments, such as in embodiments where one of the first and second arbitrary planes 752 and 754 is constrained to be perpendicular to the baseline between the first and second cameras 120 and 130, and where one of the first and second arbitrary planes defined for the second image ray 760 is also constrained to be perpendicular to the baseline, M=2, which generally corresponds to the two arbitrary planes perpendicular to the baseline. In such embodiments, the projector rotation matrix Rₚ and a projector translation vector tₚ is further constrained such that a particular 3D measurement Pₒᵢ for that particular feature i must be along the baseline. This can constrain the particular 3D measurement Pₒᵢ to sliding along the baseline until it coincides with the reference light plane Lᵢ within the sensor reference frame 128.

In other embodiments, as an alternative or an addition to equation (22), equation (23) which describes a point-to-plane ICP algorithm may be used instead at block 712 to determine whether there is any transformation between the 3D measurements of the at least one light plane 230 determined at block 702 relative to the reference light plane equation.

$${arg min}_{{R}_{p} , {t}_{p} , {s}_{p}} {\sum }_{i = 1}^{N} {‖ {s}_{p} {R}_{p} {P}_{o i} + {t}_{p} - {Q}_{o i} + {\sum }_{j = 1}^{M} ( ( {s}_{p} {R}_{p} {P}_{o i} + {t}_{p} ) - {G}_{o i j} ) ‖}^{2} \qquad ( 23 )$$

whereby N is the total number of 3D measurements of a particular feature i in images captured by the first and second cameras 120 and 130; sₚ is a scaling variable fixing factors associated with the reference light plane Lᵢ which may account for small uniform deformations in the reference light plane; Pₒᵢ is the 3D measurements of the particular feature i in the sensor reference frame 128

$$[ \begin{matrix}{\hat{x}}_{o} \\ {\hat{y}}_{o} \\ {\hat{z}}_{o}\end{matrix} ]$$

(e.g., P₆₁₀ₒᵢ and P₆₁₁ₒᵢ shown in FIG. 12), and generally corresponds to the 3D measurement of the light planes 230; Qₒᵢ is the 3D measurements of a closest point in the reference light plane Lᵢ to Pₒᵢ (determined based on the initial or previously calibrated reference light plane equations); Rₚ is the projector rotation matrix for rotating Pₒᵢ to fit Qₒᵢ; tₚ is the projector translation vector for translating Pₒᵢ to fit Qₒᵢ; M is the total number of arbitrary planes associated with a ray emanating from the first and second camera origins 121 and 131 of the first and second cameras 120 and 130 to a particular feature i in images captured by the first and second cameras 120 and 130; Gₒᵢⱼ is the 3D measurements of any point on the arbitrary planes in the sensor reference frame 128, and may be a closest point in the arbitrary plane to Pₒᵢ, and whereby the reference light plane Lᵢ is a closest reference light plane to Pₒᵢ of the plurality of reference light planes of a particular a light projector model.

In the event of any projector rotation matrix Rₚ or projector translation vector tₚ being determined, block 712 may further direct the processor 400 to calibrate the initial reference light plane equation (initially loaded at a beginning of a particular 3D scanning procedure (i.e., at a beginning of block 506)) or the current reference light plane equation (previously calibrated during a particular 3D scanning procedure (i.e., during block 506) associated with the reference light plane Lᵢ with the projector rotation matrix Rₚ and translation vector tₚ to account for shifts or movement in the actual light plane 230 corresponding to the reference light plane Lᵢ. In some embodiments, the projector rotation matrix Rₚ and translation vector tₚ may be used to calibrate only the reference light plane equation associated with one particular reference light plane Lᵢ of a light projector model; however, in other embodiments, the projector rotation matrix Rₚ and translation vector tₚ may be used to calibrate every reference light plane equation of the reference light planes of a particular light projector model.

Thereafter, the calibrate projector parameters procedure 700 may then continue to block 704, which may include codes directing the processor 400 to store the calibrated reference light plane equations and/or the least one projector parameter in the projector parameters datastore 701 for future use. For example, the calibrated reference light plane equation and/or the at least one projector parameter may be used by the processor 400 in the determine 3D measurements process 600 to generate further 3D measurements of the surface 112 of a same target object during a same particular 3D scanning procedure (i.e., during block 506). Alternatively, the calibrated reference light plane equation and/or the at least one projector parameter may be used by the processor 400 in the determine 3D measurements process 600 to generate 3D measurements of a surface 112 of another target object during a subsequent 3D scanning procedure. Further still, the calibrated reference light plane equation and/or the at least one projector parameter may also be used by the processor 400 in a subsequent instance of the first branch 711 (or a subsequent instance of the second branch 731) of the calibrate projector parameters procedure 700 to generate a further calibrated reference light plane equation. For example, the calibrated reference light plane equation may be used to define the reference light plane Lᵢ in equations (22) and (23). The calibrate projector parameters procedure 700 then end.

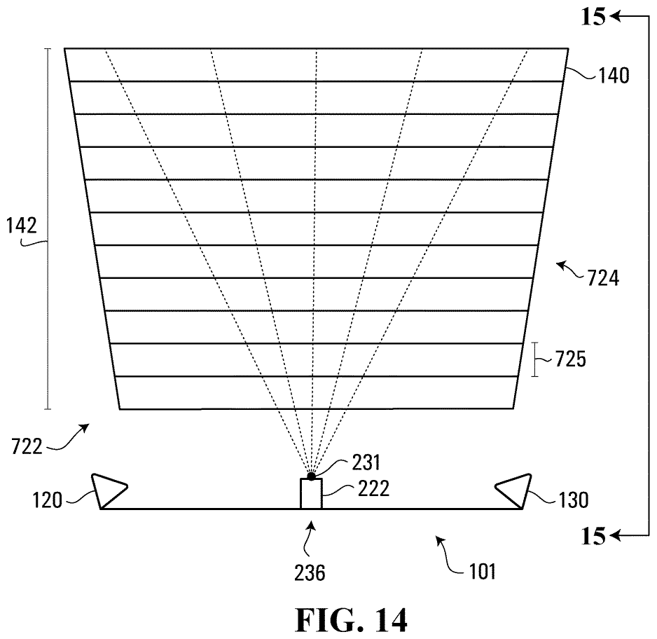

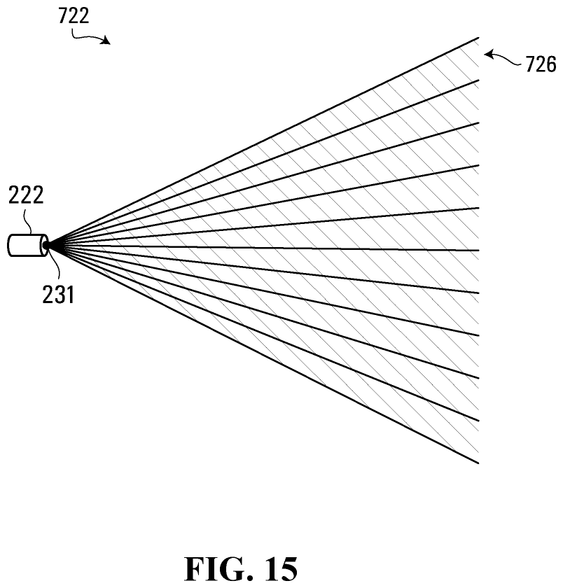

However, in certain embodiments, block 702 may determine tens of thousands and/or hundreds of thousands of initial 3D measurements for the at least one light plane 230. It may be computationally expensive to determine the projector rotation matrix Rₚ and/or the projector translation vector tₚ at block 712 based on such large numbers of initial 3D measurements, and it may not be possible to perform such algorithms in real time during the 3D scanning procedure (i.e., during block 506). Accordingly, in some embodiments, the first branch 711 may further include optional block 714, which may include codes directing the processor 400 to divide the scanner FOV 140 into a plurality of voxels 722 and associate a set of voxels of the plurality of voxels 722 with each light plane of the plurality of light planes 230. For example, referring to FIGS. 14 and 15, to generate the plurality of voxels 722, the scanner DOF 142 may be partitioned into a plurality of depth bins 724 (shown in FIG. 14) and heights (including the height 146 at the z_{projection}) of the scanner FOV 140 may be partitioned into a plurality of height bins 726 (shown in FIG. 15).

Referring to FIG. 14, in the embodiment shown, there are 12 depth bins 724; however, in other embodiments, the depth 142 may partitioned into a greater or a fewer number of depth bins 724, and may range between approximately 10 and 100 depth bins, generally depending on a dimension of the scanner DOF 142. Further, in the embodiment shown, each of the plurality of depth bins 724 are substantially identical and has a substantially equal depth 725 of approximately 117 mm; however, in other embodiments, each of the plurality of depth bins 724 may have a different depth 725, and may have depths 725 range between approximately 1 mm and 150 mm.

Referring to FIG. 15, in the embodiment shown, the heights of the scanner FOV 140 are partitioned utilizing a model of a virtual camera positioned at the projector position 236. In the embodiment shown, there are 1024 height bins 726, each corresponding to two rows of pixels of a frame which would be generated by the virtual camera at the projector position 236 and increasing in height in the world reference frame 118 as the depth 142 increases (e.g., similar to the first and second camera FOVs 123 and 133). As a result, each of the height bins 726 are angular relative to the projector origin 231. However, in other embodiments, the heights of the scanner FOV 140 may partitioned into a greater or a fewer number of height bins 726, and may comprise approximately 64, 128, 256, 512, 1024 or 2048 height bins. Further, in the embodiment shown, each of the plurality of height bins 726 are substantially identical (initially corresponding to two rows of pixels); however, in other embodiments, each of the plurality of height bins 726 may be different and may each initially correspond to a different numbers of pixels, and may each initially corresponding to any number between 1 pixel and 32 pixels.

If the depth 142 and heights are partitioned into too many depth and height bins 724 and 726, there may be too many resulting voxels 722. Too many voxels may result in too many 3D measurements of light planes 230 for the processor 400 to execute block 712 in real time during the 3D scanning procedure (i.e., during block 506). Also, there may be loss of the ability of a centroid (described below) associated with each voxel of the voxels 722 to filter out potential outliers of the 3D measurements of light planes 230, as there may be too few 3D measurements located within each voxel. On the other hand, if the depth 142 and heights are partitioned into too few depth and height bins 724 and 726, the resulting projector rotation matrix Rₚ and the projector translation vector tₚ generated by the processor 400 at block 712 may not be sufficiently accurate to accurate calibrate the reference light plane equation.

The first branch 711 may further include optional block 716, which may include codes directing the processor 400 to generate a centroid Cₜ for the 3D measurements of a particular light plane 230 within each voxel Vₜ of the plurality of voxels associated with that particular light plane 230 in a manner similar to that shown in equation (24).

$${C}_{t} = \frac{{\sum }_{i = 1}^{N} {P}_{o i}}{N} \qquad ( 24 )$$

whereby Pₒᵢ is the 3D measurements of the particular feature i in the sensor reference frame 128

$$[ \begin{matrix}{\hat{x}}_{o} \\ {\hat{y}}_{o} \\ {\hat{z}}_{o}\end{matrix} ]$$

within a particular voxel Vₜ associated with a particular light plane 230, and generally corresponds to the 3D measurements of the light plane 230 within that voxel Vₜ; and N is the total number of 3D measurements Pₒᵢ of the light plane 230 within that voxel Vₜ.

As additional 3D measurements of the light plane 230 are generated at block 702, the centroid Cₜ for the 3D measurements of the light plane 230 within each voxel Vₜ associated with that particular light plane 230 may be updated into centroid C′ₜ in a manner similar to that shown in equation (25).

$${C}_{t}^{′} = \frac{{NC}_{t} + {\sum }_{j = 1}^{M} {P}_{oj}}{N + M} \qquad ( 25 )$$

whereby Pₒⱼ is the 3D measurements of a particular feature j in the sensor reference frame 128 within the voxel Vₜ associated with the light plane 230; and M is a number of additional 3D measurements Pₒⱼ of the light plane 230 within the voxel Vₜ.

The centroid Cₜ for the plurality of voxels 722 calculated at optional block 716 may then be fed to block 712. Block 712 may then utilize the centroid Cₜ of each voxel Vₜ in the ICP algorithms shown in equations (22) and (23) as 3D measurements of the light plane 230 Pₒᵢ instead of the tens or hundreds of thousands of actual 3D measurements of the light plane 230 Pₒᵢ measured at block 702. This may increase the speed to, and reduce the computing resources required to, compute the projector rotation matrix Rₚ and the projector translation vector tₚ at block 712. This may also allow the projector rotation matrix Rₚ and the projector translation vector tₚ to be computed during the 3D scanning procedure (i.e., during block 506).

In the embodiment shown, and as described above, the processor 400 may execute the first branch 711 of calibrate projector parameters procedure 700 during the 3D scanning procedure (i.e., during block 506 shown in FIG. 6). In some embodiments, the processor 400 may execute the first branch 711 more than one time during a particular 3D scanning procedure of a particular target object. For example, the first branch 711 may be continuously executed by the processor 400 in the background. As an additional example, the processor 400 may execute the first branch 711 at set intervals, such as after a particular amount of time has passed and/or after a particular number of images and/or frames have been captured by the first and second cameras 120 and 130. In such embodiments, the first branch 711 may be a concurrent calibration procedure of at least one projector parameter. However, in other embodiments, the processor 400 may execute the first branch 711 after the 3D scanning procedure (i.e., after block 506). In such embodiments, the first branch 711 may be a post-operation calibration procedure of at least one projector parameter.

Second Branch 731: Integrate 3D Measurements into a Linearized Point Matching Procedure

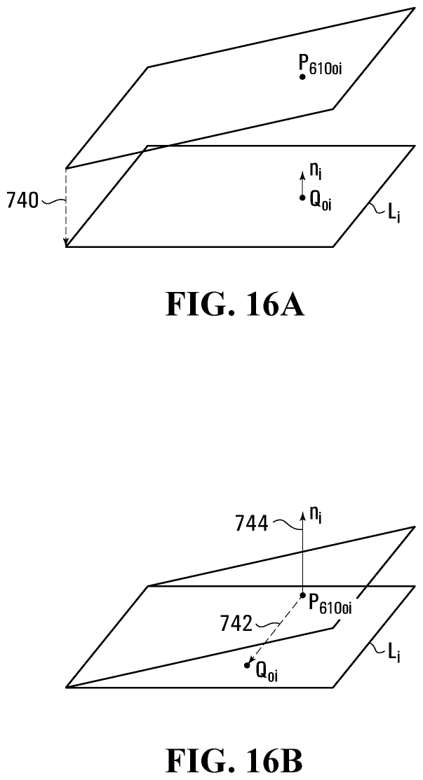

In other embodiments, rather than utilizing the full ICP algorithms shown in equations (22), (22a) and (23), the calibrate projector parameters procedure 700 may instead proceed down a second branch 731 for determining at least one projector parameter to calibrate the reference light plane equation. The second branch 731 may involve a linearized point matching system, including a linearized version of any one of the ICP algorithms shown in equations (22), (22a) and (23) for example. In this respect, and referring to FIGS. 11, 16A and 16B, either of the ICP algorithms shown in equations (22) or (22a) may be linearized by assuming that a relative rotation of the 3D measurements of the light planes 230 determined at block 702 and the reference light plane L; represented by the reference light plane equation is minimal or negligible, by assuming sinθ≈θ and cosθ≈1 (also known as a “small angle approximation”). This assumption reduces the projector rotation matrix Rₚ from a 3×3 matrix to a linearized 3×1 vector of

$$[ \begin{matrix}{r}_{x} \\ {r}_{y} \\ {r}_{z}\end{matrix} ]$$

(e.g., a linearized projector rotation vector rₚ). The projector translation vector tₚ is already a linearized 3×1 vector of

$$[ \begin{matrix}{t}_{x} \\ {t}_{y} \\ {t}_{z}\end{matrix} ] .$$

This in turn allows the point-to-plane ICP algorithm of equation (22) (simplified version shown in equation (24) below) to be expanded to equation (25). Only linearization of the unconstrained point-to-plane ICP algorithm shown in equation (22) is described below for clarity; however those skilled in the art will recognized that the constrained ICP algorithms shown in equations (22a) and (23) may be similarly linearized.

$${{arg min}_{{r}_{p} , {t}_{p}} {\sum }_{i = 1}^{N} ( ( {R}_{p} {P}_{o i} + {t}_{p} ) - {Q}_{o i} ) \cdot {n}_{o i} )}^{2} \qquad ( 24 )$$

$${arg min}_{{r}_{p} , {t}_{p}} {\sum }_{i = 1}^{N} {( ( {P}_{o i} - {Q}_{o i} ) \cdot {n}_{o i} + {r}_{p} \cdot ( {P}_{o i} \times {n}_{o i} ) + {t}_{p} \cdot {n}_{o i} )}^{2} \qquad ( 25 )$$

whereby N is the total number of 3D measurements of a particular feature i in frames captured by the first and second cameras 120 and 130; Pₒᵢ is the 3D measurements of the particular feature i in the sensor reference frame 128

$$[ \begin{matrix}{\hat{x}}_{o} \\ {\hat{y}}_{o} \\ {\hat{z}}_{o}\end{matrix} ]$$

(e.g., P₆₁₀ₒᵢ and P₆₁₁ₒᵢ shown in FIG. 12), and generally corresponds to the 3D measurement of the light planes 230; Qₒᵢ is the 3D measurements of any point in the reference light plane Lᵢ in the sensor reference frame 128 (in the embodiment shown, determined by an initial reference light plane equation initially loaded at a beginning of a particular 3D scanning procedure (i.e., at a beginning of block 506); however, in other embodiments, the reference light plane Lᵢ may be represented by a current reference light plane equation previously calibrated during a particular 3D scanning procedure (i.e., during block 506)), and may be a closest point in the reference light plane Lᵢ to Pₒᵢ; nₒᵢ is a normal vector of Qₒᵢ in the reference light plane Lᵢ; rₚ is the linearized projector rotation matrix for rotating Pₒᵢ to fit Qₒᵢ, assuming sinθ≈θ and cosθ≈1; tₚ is the projector translation vector for translating Pₒᵢ to fit Qₒᵢ; and whereby the reference light plane Lᵢ is a closest reference light plane to Pₒᵢ of the plurality of reference light planes of a particular a light projector model.

Referring to FIGS. 16A and 16B and equation (25), relative changes between a matched 3D measurement of the light planes 230 Pₒᵢ and a point Qₒᵢ in the reference light plane Lᵢ can be described by the vector [rₚ×Pₒᵢ+tₚ] (due to the linearization of Rₚ), where tₚ represents a normal vector 740 exerted by Pₒᵢ on Qₒᵢ (shown in FIG. 16A) and where rₚ represents a torque vector 742 (shown in FIG. 16B) exerted by Pₒᵢ on Qₒᵢ relative to a Pₒᵢ×nₒᵢ axis 744 (again shown in FIG. 16B). Additionally, still referring to FIGS. 16A and 16B and equation (25), a Pₒᵢ which has a normal vector 740 perpendicular to tₚ does not change a transformation calculated by equation (25). Similarly, a Pₒᵢ which has a torque vector 742 perpendicular to rₚ does not change a transformation calculated by equation (25). As a result, a partial derivative of equation (25) with respect to tₚ and rₚ results in a linearized point matching system of equation (26):

$$A x = b \qquad ( 26 )$$

whereby A is a 6×6 covariance matrix of the normal vector 740 and the torque vector 742 contributed by different sets of matched Pₒᵢ and Qₒᵢ, namely

$$[ \begin{matrix}{P}_{1 o i} \times {n}_{1 o i} & … & {P}_{k o i} \times {n}_{k o i} \\ {n}_{1 o i} & … & {n}_{k o i}\end{matrix} ] [ \begin{matrix}{( {P}_{1 o i} \times {n}_{1 oi} )}^{T} & {n}_{1 oi}^{T} \\ … & … \\ {( {P}_{k o i} \times {n}_{koi} )}^{T} & {n}_{koi}^{T}\end{matrix} ] ;$$

x is a 6×1 vector of tₚ and rₚ, namely

$$[ \begin{matrix}{r}_{x} \\ {r}_{y} \\ {r}_{z} \\ {t}_{x} \\ {t}_{y} \\ {t}_{z}\end{matrix} ] ;$$

and b is a 6×1 residual vector describing error in A, namely

$$[ \begin{matrix}- ( {P}_{1 oi} - {Q}_{1 oi} ) \\ … \\ - ( {P}_{koi} - {Q}_{koi} )\end{matrix} ] .$$

A thus describes the tₚ and rₚ for transforming all Pₒᵢ to all corresponding Qₒᵢ (different sets of matched Pₒᵢ and Qₒᵢ) of in a reference light plane Lᵢ of the plurality of reference light planes of a particular light projector model and b describes a residual error of that transformation. As discussed above and below, the reference plane reference equation corresponding to the reference light plane Lᵢ used within the linearized point matching system may be the initial reference light plane equation determined at startup of a particular 3D scanning procedure. Utilizing the light projector model and the initial reference light plane equation determined at startup of a particular 3D scanning procedure (i.e., at a beginning of block 506) maintains validity of the A and b matrices as additional 3D measurements Pₒᵢ from additional images are captured by the first and second cameras 120 and 130 and are integrated into the linearized point matching system by the processor 400 as described below.

Accordingly, in the embodiment shown, the second branch 731 includes block 732, which may include codes directing the processor 400 to integrate 3D measurements of the light planes 230 determined at block 702 into the linearized point matching system described above to derive at least one projector parameter for calibrating an initial reference light element equation.

For example, in some embodiments, block 732 may direct the processor 400 to generate a new C matrix and a new b matrix for the 3D measurements Pₒᵢ determined (e.g., at block 702) utilizing a particular image captured by the first and second cameras 120 and 130 for a particular tₙ and the corresponding Qₒᵢ generated utilizing the initial reference light plane determined at startup of a particular 3D scanning procedure (i.e., at a beginning of block 506). Referring to FIG. 12, new 3D measurements P₆₁₀ₒᵢ for a feature i, P₆₁₀₀ᵢ₁ for a feature i1 and P₆₁₀₀ᵢ₂ for a feature i2 determined from the first image 610A, together with corresponding Qₒᵢ for the feature i, Qₒᵢ₁ for the feature i1 and corresponding Qₒᵢ₂ for the feature i2 determined from the initial reference light plane may be used to generate a corresponding A_{610A} for the first image 610A as

$$[ \begin{matrix}{P}_{610 oi} \times {n}_{610 oi} & {P}_{610 oi 1} \times {n}_{610 oi 1} & {P}_{610 oi 2} \times {n}_{610 oi 2} \\ {n}_{610 oi} & {n}_{610 oi 1} & {n}_{610 oi 2}\end{matrix} ] [ \begin{matrix}{( {P}_{610 o i} \times {n}_{610 oi} )}^{T} & {n}_{610 oi}^{T} \\ {( {P}_{610 o i 1} \times {n}_{610 oi 1} )}^{T} & {n}_{610 oi 1}^{T} \\ {( {P}_{610 o i 2} \times {n}_{610 oi 2} )}^{T} & {n}_{610 oi 2}^{T}\end{matrix} ]$$

generate an augmented C matrix for each frame, and may be used to generate a corresponding b_{610A} for the first image 610A.

$$[ \begin{matrix}- ( {P}_{610 o i} - {Q}_{oi} ) \\ - ( {P}_{610 o i 1} - {Q}_{oi 1} ) \\ - ( {P}_{610 o i 2} - {Q}_{oi 2} )\end{matrix} ] .$$

To allow the processor 400 to execute the calibrate projector parameters procedure 700 faster, in some embodiments, block 732 may direct the processor 400 to generate a new A matrix and a new b matrix for a particular image using the centroids Cₜ of each voxel Vₜ calculated at optional block 716 of the first branch 711 for that particular image, rather than raw 3D measurements Pₒᵢ determined block 702 for that particular image. As discussed above in association with the first branch 711, utilizing the centroids Cₜ of each voxel Vₜ, rather than the tens or hundreds of thousands of raw 3D measurements Pₒᵢ, may further increase the speed to, and reduce the computing resources required to, generate a new A matrix and a new b matrix, and in turn to determine the projector rotation vector rₚ and the projector translation vector tₚ as described below. This may also allow the processor 400 to determine the projector rotation vector rₚ and the projector translation vector tₚ during the scanning procedure (i.e., during block 506).

In some embodiments, such as when the first image 610A is the first image captured during a particular 3D scanning procedure (i.e., during block 506), block 732 may the direct the processor 400 to integrate the A_{610A} and b_{610A} generated using the first image 610A into equation (26) to determine the projector rotation vector rₚ and the projector translation vector tₚ. Merely solving for x in equation (27) to generate the projector rotation vector rₚ and the projector translation vector tₚ may be less computationally expensive than solving the ICP algorithms of equations (22), (22a) and (23) to determine projector rotation matrix Rₚ and the projector translation vector tₚ. This may allow the linearized projector rotation vector rₚ and the projector translation vector tₚ to be computed during the 3D scanning procedure (i.e., during block 506).

In the event of any projector rotation vector rₚ and any projector translation vector tₚ being determined, block 732 may also direct the processor 400 to calibrate the initial reference light plane equation (e.g., initially loaded at a beginning of a particular 3D scanning procedure (i.e., at a beginning of block 506), and used to determine the corresponding Qₒᵢ, Qₒᵢ₁, and Qₒᵢ₃) associated with the reference light plane Lᵢ with the determined the projector rotation vector rₚ and the projector translation vector tₚ.

The calibrate projector parameters procedure 700 may then continue to block 704 as described above, and the processor 400 may store the calibrated reference light plane equation, the at least one projector parameter and/or the determined A_{610A} and b_{610A} matrices in the projector parameters datastore 701 for future use. For example, the calibrated reference light plane equation and/or projector rotation vector rₚ and any projector translation vector tₚ may be used by the processor 400 in the determine 3D measurements process 600 to generate further 3D measurements of the surface 112 of a same target object during a same particular 3D scanning procedure (i.e., during block 506) or to generate 3D measurements of a surface 112 of another target object during a subsequent 3D scanning procedure. Further still, the determined A_{610A} and b_{610A} matrices may also be used by the processor 400 in a subsequent instance of the second branch 731 of the calibrate projector parameters procedure 700 to generate a further calibrated reference light plane equation as described below. The calibrate projector parameters procedure 700 then end.

In other embodiments, such as when the first image 610A is a subsequent image captured during a particular 3D scanning procedure (i.e., during block 506), the A_{610A} and b_{610A} generated using the first image 610A may be integrated with existing A and b matrices generated using 3D measurements Pₒᵢ determined from previous images captured by the first and second cameras 120 and 130 (and corresponding Qₒᵢ generated utilizing the initial reference light plane determined at startup of a particular 3D scanning procedure (e.g., at a beginning of block 506)) in accordance with equations (27) and (28) below. The simple integration by way of addition in equations (27) and (28) is possible due to the linear nature of the linearized point matching system of equation (26) as described above. The existing A and b matrices may be stored in the projector parameters datastore 701.

$${A}^{′} = {A}_{s} + {A}_{M} \qquad ( 27 )$$

$${b}^{′} = {b}_{s} + {b}_{M} \qquad ( 28 )$$

whereby Aₛ and bₛ are one or more respective matrices determined using previous images captured by the first and second cameras 120 and 130, and which may be stored in the projector parameters datastore 701; and A_{M} and b_{M} are the matrices determined using a current image captured by the first and second cameras 120 and 130 (e.g., A_{610A} and b_{610A} determined using the first image 610A).

Block 732 may the direct the processor 400 to integrate the A′ and b′ matrices generated using a combination of the current image and previous images the first image 610A into equation (26) to determine the projector rotation vector rₚ and the projector translation vector tₚ. In some embodiments, block 732 may direct the processor 400 to wait to integrate the A′ and b′ matrices of different images together as shown in equations (27) and (28)—and/or wait to integrate the A′ and b′ matrices of different images into equation (26) to determine the projector rotation vector rₚ and the projector translation vector tₚ—until a sufficient number of 3D measurements Pₒᵢ of light planes 230 have been determined at block 702 (or the centroids Cₜ of each voxel Vₜ calculated at optional block 716 is an average of a sufficient number of 3D measurements Pₒᵢ). The sufficient number of 3D measurements Pₒᵢ may be a global sufficiency number associated with the 3D measurements Pₒᵢ which can be corresponded to any reference light plane Lᵢ of a particular reference light projector model. For example, the global sufficiency number may be anywhere between 10000 and 200000 3D measurements Pₒᵢ. Additionally or alternatively, the sufficient number of 3D measurements Pₒᵢ may be a plane-based sufficiency number associated with the 3D measurements Pₒᵢ which can be corresponded to a particular reference light plane (e.g., L₁,L₂,L₃,L₄ or L₅ shown in FIG. 13). For example, the plane-based sufficiency number may be anywhere between 100 and 2000 3D measurements Pₒᵢ.

As a more specific example, in embodiments where the global sufficiency number of 3D measurements Pₒᵢ is 100000 and each image generates approximately 25000 3D measurements Pₒᵢ, block 732 may direct the processor 400 to (a) integrate matrices A₁+A2+A₃+A4 (for first, second, third and fourth images respectively) together as A′ and integrate matrices b₁+b2+b₃+b4 (for the first, second, third and fourth images respective) together as b′ only after capturing at least the first, second, third and fourth images using the first and second cameras 120 and 130, (c) integrate the A′ and b′ matrices into equation (26) to determine the projector rotation vector rₚ and the projector translation vector tₚ, and (d) store the matrices A₁, A₂, A3, A4, b1, b2, b3 and b4 in the projector parameters datastore 701 as described below. Thereafter, as each additional image (e.g., a fifth image) is captured by the first and second cameras 120 and 130, block 732 may direct the processor 400 to integrate matrices A₅ and b₅ of the fifth image with the matrices of the first to fourth images as A1 +A2 +A3 +A4 +A5 and b₁ +b2 +b3 +b4 +b5 to generate the A′ and the b′.

Accordingly, block 732 may be performed for every image, or after a number of images have been, captured by the first and second cameras 120 and 130. Merely integrating the A_{M} and b_{M} matrices of a current image with one or more respective Aₛ and bₛ matrices of previous images (e.g., by way of addition) may also be less computationally expensive than solving the ICP algorithms of equations (22), (22a) and (23). Additionally, as described above, merely solving for x in equation (27) to generate the projector rotation vector rₚ and the projector translation vector tₚ may also be less computationally expensive than solving the ICP algorithms of equations (22), (22a) and (23) to determine projector rotation matrix Rₚ and the projector translation vector tₚ. This combination may allow the linearized projector rotation vector rₚ and the projector translation vector tₚ to be computed during the 3D scanning procedure (i.e., during block 506).

Again, in the event of any projector rotation vector rₚ and any projector translation vector tₚ being determined using A′ and b′, block 732 may direct the processor 400 to calibrate the initial reference light plane equation (e.g., initially loaded at a beginning of a particular 3D scanning procedure (i.e., at a beginning of block 506), and used to determine the corresponding Qₒᵢ for each of the A and b matrices of the current image and previous images) associated with the reference light plane Lᵢ with the determined the projector rotation vector rₚ and the projector translation vector tₚ. The calibrate projector parameters procedure 700 then continue to block 704 as described above, and the processor 400 may store the calibrated reference light plane equation and/or the determined A and b matrices in the projector parameters datastore 701 for future use. The calibrate projector parameters procedure 700 then end.

In some embodiments, validity of the linearized point matching system generated using images captured by the first and second cameras 120 and 130 up to a particular point in time tₙ can be analyzed to ensure that the linearized point matching system is stable. In this regard, block 732 may direct the processor 400 to determine a condition number associated with the linearized point matching system generated using images captured up to tₙ, and in particular a condition number associated with the covariance matrix A. For example, block 732 may direct the processor 400 to assess whether the condition number of eigenvectors and eigenvalues of the covariance matrix A is sufficiently close to 1. In some embodiments, if the condition number is too far away from 1 or the linearized point matching system is otherwise unstable, the processor 400 may direct the processor to default back to performing the first branch 711 instead of performing the second branch 731 of the calibrate projector parameters procedure 700.

In the embodiment shown, the processor 400 may execute the second branch 731 of calibrate projector parameters procedure 700 during the 3D scanning procedure (i.e., during block 506 shown in FIG. 6). In some embodiments, the processor 400 may execute the second branch 731 more than one time during a particular 3D scanning procedure. For example, the second branch 731 may be continuously executed by the processor 400 in the background, such as after every new image is captured by the first and second cameras 120 and 130. As an additional example, the processor 400 may execute the second branch 731 at set intervals, such as after a particular amount of time has passed and/or after a particular number of images have been captured by the first and second cameras 120 and 130. In such embodiments, the second branch 731 may be a concurrent calibration procedure of at least one projector parameter. However, in other embodiments, the processor 400 may execute the second branch 731 after the 3D scanning procedure (i.e., after block 506). In such embodiments, the second branch 731 may be a post-operation calibration procedure of at least one projector parameter.

### Operation

The term “substantially” and “approximately” means a proportion of at least about 60%, or at least about 70% or at least about 80%, or at least about 90%, at least about 95%, at least about 97% or at least about 99% or more, or any integer between 70% and 100%.

The expression “at least one of A or B”, as used herein, is interchangeable with the expression “A and/or B” and refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The above interpretation applies for longer lists having a same format.

In some embodiments, any feature of any embodiment described herein may be used in combination with any feature of any other embodiment described herein.

Certain additional elements that may be needed for operation of certain embodiments have not been described or illustrated as they are assumed to be within the purview of those of ordinary skill in the art. Moreover, certain embodiments may be free of, may lack and/or may function without any element that is not specifically disclosed herein.

It will be understood by those of skill in the art that throughout the present specification, the term “a” used before a term encompasses embodiments containing one or more to what the term refers. It will also be understood by those of skill in the art that throughout the present specification, the term “comprising”, which is synonymous with “including,” “containing,” or “characterized by,” is inclusive or open-ended and does not exclude additional, un-recited elements or method steps. As used in the present disclosure, the terms “around”, “about” or “approximately” shall generally mean within the error margin generally accepted in the art. Hence, numerical quantities given herein generally include such error margin such that the terms “around”, “about” or “approximately” can be inferred if not expressly stated.

In describing embodiments, specific terminology has been resorted to for the sake of description, but this is not intended to be limited to the specific terms so selected, and it is understood that each specific term comprises all equivalents. In case of any discrepancy, inconsistency, or other difference between terms used herein and terms used in any document incorporated by reference herein, meanings of the terms used herein are to prevail and be used.

References cited throughout the specification are hereby incorporated by reference in their entirety for all purposes.

Although various embodiments of the disclosure have been described and illustrated, it will be apparent to those skilled in the art in light of the present description that numerous modifications and variations can be made. The scope of the invention is defined more particularly in the appended claims.

What is claimed is:

1. A method for calibrating a three-dimensional (3D) scanner having a projector, a set of cameras and at least one processor in communication with the projector and the set of cameras, the method comprising:
a. projecting, with the projector, a plurality of light elements which resolve as a light pattern on a surface of an object;
b. capturing, with the set of cameras, a plurality of frames of the surface, wherein a set of images of the plurality of frames include data conveying a representation of at least a portion of the light pattern on the surface and at least a portion of the surface;
c. processing, with the at least one processor, the set of images to:
i. generate 3D measurements of the surface by processing the representation of at least the portion of the surface in the set of images; and
ii. generate 3D measurements of at least one light element of the plurality of light elements by processing the representation of at least the portion of the light pattern on the surface in the set of images;
d. grouping, with the at least one processor, the 3D measurements of the at least one light element into a plurality of centroids, each centroid of the plurality of centroids representing a collapsed version of a subset of the 3D measurements of the at least one light element;
e. processing, with the at least one processor, the plurality of centroids to derive at least one projector parameter; and
f. calibrating, with the at least one processor, a reference light element corresponding to the at least one light element and represented by a reference light element equation with the at least one projector parameter to generate a calibrated reference light element equation.

2. The method of claim 1, wherein grouping the 3D measurements of the at least one light element into the plurality of centroids comprises:
a. dividing, with the at least one processor, a scanner field-of-view (FOV) into a plurality of voxels, wherein a set of voxels of the plurality of voxels are associated with the at least one light element; and
b. grouping, with the at least one processor, the 3D measurements of the at least one light element within each voxel of the set of voxels into a centroid, wherein centroids of each voxel of the set of voxels associated with the at least one light element comprise the plurality of centroids.

3. The method of claim 1, wherein deriving the at least one projector parameter based on the plurality of centroids comprises at least one of:
a. performing an iterative closest point operation between the plurality of centroids and points of the reference light element; or
b. integrating the plurality of centroids into a linearized point matching system.

4. The method of claim 1, wherein the at least one projector parameter comprises at least one of:
a. a rotation matrix of the 3D measurements of the at least one light element relative to the reference light element; or
b. a translation vector of the 3D measurements of the at least one light element relative to the reference light element.

5. A method for calibrating a three-dimensional (3D) scanner having a projector, a set of cameras and at least one processor in communication with the projector and the set of cameras, the method comprising:
a. projecting, with the projector, a plurality of light elements which resolve as a light pattern on a surface of an object;
b. capturing, with the set of cameras, a plurality of frames of the surface, wherein a set of images of the plurality of frames include data conveying a representation of at least a portion of the light pattern on the surface and at least a portion of the surface;
c. processing, with the at least one processor, the set of images to:
iii. generate 3D measurements of the surface by processing the representation of at least the portion of the surface in the set of images; and
iv. generate 3D measurements of at least one light element of the plurality of light elements by processing the representation of at least the portion of the light pattern on the surface in the set of images;
d. integrating, with the at least one processor, the 3D measurements of the at least one light element into a linearized point matching system;
e. processing, with the at least one processor, the linearized point matching system to derive at least one projector parameter; and
f. calibrating, with the at least one processor, a reference light element corresponding to the at least one light element and represented by a reference light element equation with the at least one projector parameter to generate a calibrated reference light element equation.

6. The method of claim 5, wherein the linearized point matching system comprises a linearized iterative closest point operation between the 3D measurements of the at least one light element and points of the reference light element and wherein integrating the 3D measurements of the at least one light element into the linearized point matching system comprises:
a. generating at least one matrix based on the 3D measurements of the at least one light element and the points of the reference light element; and
b. integrating the at least one matrix into the linearized iterative closest point operation to generate the at least one projector parameter.

7. The method of claim 6, wherein the at least one matrix comprises:
a. a covariance matrix of normal vectors and torque vectors of the 3D measurements of the at least one light element relative to points of the reference light element; and
b. a residual vector of the linearized iterative closest point operation.

8. The method of claim 6, wherein:
a. generating the at least one matrix based on the 3D measurements of the at least one light element comprises generating a respective at least one matrix for each image of the set of images; and
b. integrating the at least one matrix into the linearized iterative closest point operation comprises integrating each respective at least one matrix generated based on each image of the set of images into the linearized iterative closest point operation.

9. The method of claim 6, wherein the at least one projector parameter comprises at least one of:
a. a rotation vector of the 3D measurements of the at least one light element relative to the points of the reference light element; or
b. a translation vector of the 3D measurements of the at least one light element relative to the points of the reference light element.

10. The method of claim 9, wherein the rotation vector of the 3D measurements of the at least one light element relative to the points of the reference light element comprises a linearized rotation matrix of the 3D measurements of the at least one light element relative to the points of the reference light element.

11. The method of claim 5, wherein the reference light element equation comprises an initial reference light element equation.

12. The method of claim 1, further comprising storing at least one of the at least one projector parameter or the calibrated reference light element equation in storage memory.

13. The method of claim 1, wherein the plurality of light elements comprises a plurality of light planes and the reference light element comprises a plurality of reference light planes, wherein every light plane of the plurality of light planes corresponds to a respective reference light plane of the plurality of reference light planes.

14. The method of claim 1, wherein the at least one projector parameter is derived:
a. at least in part while images of the set of images or the plurality of frames are being processed with the at least one processor to generate the 3D measurements of the surface;
b. at least in part while capturing additional images of the plurality of frames or additional images of the set of images with the set of cameras;
c. after processing images of the set of images or the plurality of frames with the at least one processor to generate the 3D measurements of the surface; or
d. after capturing images of the set of images or images of the plurality of frames with the set of cameras.

15. The method of claim 1, wherein the plurality of frames comprises a plurality of subsets of frames and wherein the at least one projector parameter is derived at intervals after capturing images of a subset of the plurality of subsets of frames with the set of cameras.

16. The method of claim 1, further comprising causing the at least one processor to generate the 3D measurements of the surface based on least in part on the calibrated reference light element equation.

17. The method of claim 16, wherein the plurality of frames form a first set of frames, said method further comprising:
a. capturing, with the set of cameras, a second set of frames of the surface; and
b. processing, with the at least one processor, the second set of frames to generate further 3D measurements of the surface based at least in part on the calibrated reference light element equation.

18. The method of claim 1, wherein the object has a scale artifact fixedly associated with the object and wherein the set of images includes data conveying a representation of at least a portion of the scale artifact, and wherein processing the set of images further comprises:
a. processing, with the at least one processor, the set of images to derive at least one derivable camera parameter of the set of cameras by processing dimension information corresponding to the scale artifact and the representation of at least the portion of the scale artifact in the set of images.

19. The method of claim 18, wherein the scale artifact includes a physical scale element and a nominal scale element, wherein the nominal scale element provides the dimension information of the physical scale element.

20. The method of claim 18, wherein the set of cameras comprises a first camera and a second camera and the at least one derivable camera parameter comprises a camera separation distance between the first camera and the second camera.

21. The method of claim 18, wherein the at least one derivable camera parameter comprises respective separation distances between respective cameras of the set of cameras and an origin point of the scanner.

22. The method of claim 18, further comprising calibrating, with the at least one processor, one or more calibratable camera parameters of the set of cameras at least in part using the at least one derivable camera parameter, wherein the one or more calibratable camera parameters comprises at least one of: (i) one or more extrinsic camera parameters; or (ii) one or more intrinsic camera parameters.

23. (canceled)

24. (canceled)

25. The method of claim 18, wherein the at least one derivable camera parameter is derived at least one of:
a. at least in part while images of the plurality of frames or the set of images are being processed with the at least one processor to generate the 3D measurements of the surface;
b. at least in part while capturing additional images of the plurality of frames or additional images of the set of images with the set of cameras; or
c. after processing the plurality of frames or the set of images with the at least one processor to generate the 3D measurements of the surface or after capturing images of the plurality of frames or the set of images with the set of cameras.

26. A scanner comprising a set of cameras, a projector and at least one processor, wherein the set of cameras, the projector and the at least one processor are configured to perform the method of claim 46.

27.-45. (canceled)

46. A method for calibrating a three-dimensional (3D) scanner having a projector, a set of cameras and at least one processor in communication with the projector and the set of cameras, the method comprising:
a. projecting, with the projector, a plurality of light elements which resolve as a light pattern on a surface of an object;
b. capturing, with the set of cameras, a plurality of frames of the surface, wherein a set of images of the plurality of frames include data conveying a representation of at least a portion of the light pattern on the surface and at least a portion of the surface;
c. processing, with the at least one processor, the set of images to:
i. generate 3D measurements of the surface by processing the representation of at least the portion of the surface in the set of images; and
ii. generate 3D measurements of at least one light element of the plurality of light elements by processing the representation of at least the portion of the light pattern on the surface in the set of images;
d. processing, with the at least one processor, the 3D measurements of the at least one light element to derive at least one projector parameter; and
e. calibrating, with the at least one processor, a reference light element corresponding to the at least one light element and represented by a reference light element equation with the at least one projector parameter to generate a calibrated reference light element equation.
